(19) United States
(12) Patent Application Publication
(10) Pub. No.: US 2004/0046147 A1
(43) Pub. Date: Mar. 11, 2004

(54) Thermal storage medium, process for producing the same and thermal storage system using the same

(75) Inventors: Yasuhiro Matsuda, Kakogawa-shi (JP); Tomomi Ieuji, Ibo-gun (JP)

Correspondence Address: SUGHRUE MION, PLLC, 2100 PENNSYLVANIA AVENUE, N.W., WASHINGTON, DC, 20037, US

(73) Assignee: NIPPON SHOKUBAI CO., LTD.

(21) Appl. No.: 10/423,031

(22) Filed: Apr. 25, 2003

(30) Foreign Application Priority Data
Apr. 26, 2002 (JP) 2002-126417
Apr. 26, 2002 (JP) 2002-126418
Nov. 8, 2002 (JP) 2002-325874
Dec. 4, 2002 (JP) 2002-352605
Dec. 19, 2002 (JP) 2002-368746
Dec. 27, 2002 (JP) 2002-379524
Jan. 31, 2003 (JP) 2003-23371

(51) Int. Cl. C09K 3/18

(52) U.S. Cl. 252/70

(57) ABSTRACT

The present invention is a thermal storage medium obtained by dispersing, in an oil-in-water manner, a mixture comprising an oil substance having a thermal storing property by phase change, an aqueous medium and a dispersant, wherein an amount of change in a volume average particle diameter of a dispersion of said oil substance after carrying out a 50 times of repetition of solidification/melting by phase change is within ±50% relative to a volume average particle diameter before carrying out the repetition of solidification/melting.

### TECHNICAL FIELD

The present invention relates to a thermal storage medium, a process for producing the thermal storage medium, and a thermal storage apparatus or a thermal storage system formed by using the thermal storage medium. The thermal storage medium comprises a water dispersion containing, as an essential component, an oil substance having thermal storing property by phase change, and which can be employed for heat storage systems in air conditioning systems for large constructions such as office buildings and factories and for home use.

### BACKGROUND ART

As a thermal storage oil substance utilizing latent heat, aliphatic hydrocarbons, fatty acids and fatty acid esters are known. Such a thermal storage oil substance has a characteristic to release heat upon phase change from solid to liquid and to absorb heat upon phase change from liquid to solid, and technologies which utilize this characteristic to the thermal storage system and for the purpose of saving and increasing efficiency of air conditioning energy as well as environmental protection receive attention. For example, as a thermal storage apparatus employing the thermal storage medium including the thermal storage oil substance, there is utilized an-apparatus in which the thermal storage medium is cooled and solidified by circulating the thermal storage medium between a thermal storage tank and a refrigerator to thereby intend to utilize the heat absorbing effect on its melting for cooling.

To effectively utilize such thermal storage oil substances, there is proposed a method of preparing an oil-in-water type emulsion of a thermal storage oil substance and water by using a surfactant and using the same. Conventionally, the emulsion type thermal storage medium obtained by dispersing the oil substance having the thermal storing property by phase change in water had a problem that the emulsion broke (was separated into the oil substance and water) due to a repetition of solidification/melting by phase change of the thermal storage medium and the thermal storage medium could not be used stably over an extended time period. Therefore, means of retaining the oil substance inside of lipophilic polymer particles or encapsulating the oil substance have been used in order to use the emulsion over an extended time period.

In Japanese Kokai Publication Sho-57-40582 (page 1), a thermal storage material which contains an emulsion comprising paraffin, water and a surfactant is disclosed. In Japanese Kokai Publication 2000-336350 (page 2), a thermal storage material which comprises an emulsion obtained by using a saturated hydrocarbon involving phase change, water, a surfactant and a specific nucleating agent is disclosed. However, regarding these thermal storage materials, the concentration of the surfactant in water and the surfactant at a thermal storage temperature is not considered, and there is room for contrivance to reduce the load on a circulating pump and improve the stability of the emulsion, for example, in case of circulating the thermal storage material between a thermal storage tank and a refrigerator. Also, regarding such thermal storage materials, there is room for contrivance in terms of improving a thermal storage efficiency by rendering a solidifying point easy to be adjusted, namely, making the thermal storage medium easy to be solidified in conformity with the thermal storage apparatus, or in terms of improving a thermal storing property by allowing the thermal storage material to be solidified easily at the time of storing heat and the temperature to be lowered during releasing heat because a solidifying point approaches a melting point, and further improving a thermal storing performance by enhancing the latent heat.

In Japanese Kokai Publication Hei-9-255944 (pages 2 to 4), a thermal storage material comprising a mixture of hydrocarbon, a surfactant and water is disclosed. It was found that this thermal storage material which is composed of hydrocarbon, the surfactant and water did not fall within a specified viscosity range when the present inventors examined and verified Examples. Accordingly, there is room for contrivance to improve the fluidity and the stability of the emulsion.

Regarding a dispersion of a thermal storage material, Japanese Kokai Publication 2002-53850 (pages 2 to 4) discloses a dispersion of fine particles of a thermal storage material of which the viscosity at 25° C. falls within a specific range and which is used for a stratification type thermal storage application. In this technology, the fine particles of the thermal storage material is dispersed by using a dispersant, but only a water-soluble polymer is used as the dispersant in the example, and therefore there is room for contrivance to improve the stability of the emulsion.

WO 99/15602 pamphlet (No. 2, pages 21 to 24) discloses that with respect to a composite particle for a heat carrying medium, in which the oil substance is retained inside of specific lipophilic polymer particles, the heat carrying medium is obtained by adding a mixed solution of the oil substance and the monomer component including a crosslinkable monomer to an aqueous solution containing the surfactant and polymerizing the mixture. Since such a heat carrying medium can sufficiently prevent the oil substance from exuding from the polymer upon usage, it is a favorable as the heat carrying medium used to air conditioning systems and the like. It is also described that, in producing the heat carrying medium, it may be obtained by suspension polymerization in the presence of a protective colloid agent. Further, Japanese Kokai Publication Hei-5-237368 (pages 2, 3) discloses that, with respect to a microcapsule capsulating a compound involving phase change, it can be used for thermal storage material application and that a thermal storage material dispersion can be obtained by adding a solvent and/or an additive, if necessary.

However, when applying these technologies to the thermal storage medium, there is room for contrivance for improving the heat transfer performance and reducing the load on a circulating pump by improving the fluidity, as well as for improving the stability of the heat carrying medium. When the oil substance having the thermal storing property by phase change is retained inside of lipophilic polymer particles, the content of the oil substance in the heat carrying medium is reduced by an amount corresponding to the lipophilic polymer particles used, and therefore the latent heat is reduced; therefore, there is room for contrivance also in this point. Further, there is room for contrivance to improve dispersibility and fluidity of the oil substance and stability of the emulsion by studying the constituents of the heat carrying medium obtained by such the production methods in order to render the thermal storage medium to the one having high dispersion stability against a thermal storage cycle in which solidification/melting is repeated in an operation of storing/releasing of heat.

Japanese Kokai Publication Hei-4-222894 (page 2) discloses a medium for the heat-transferring system which is obtained by mixing water as a continuous phase with tetradecane as one of paraffins as the thermal storage substance to form a dressing and dispersing tetradecane by using a homogenizer. Japanese Kokai Publication 2000-336350 (page 2, 3) discloses that, with respect to a thermal storage material comprising an emulsion using saturated hydrocarbons, one obtained by using n-hexadecane as hydrocarbon involving phase change, n-octadecane as a nucleating agent, polyoxyethylene stearyl ether as a surfactant, and water as a dispersing medium and agitating these with a mixer. However, these are not one disclosed from a standpoint of an emulsifier capable of producing the thermal storage material efficiently. In the production of the thermal storage material, an emulsifier is usually located in a mixing tank and the thermal storage oil substance is dispersed in water. In this case, it is necessary to install a dedicated mixing tank and mount a large emulsifier as shown in FIG. 3, and therefore it takes much cost in constructing a production facility.

Further, in Japanese Kokai Publication Hei-6-249587 (pages 1 to 3), a cold storage system constructed from an emulsion thermal storage material, a thermal storage tank, pipings, a circulating pump and a heat pump is disclosed. However, in such a thermal storage system, when the dispersion in the emulsion thermal storage material is broken and separated into an oil phase and a water phase, it is required to use a plurality of circulation pumps in order to re-emulsify the broken dispersion and it is inefficient; therefore, there is room for contrivance to re-emulsify the emulsion thermal storage material more easily and efficiently. Further, for the thermal storage medium of this thermal storage system, there is room for contrivance also in terms of preventing supercooling and being easy to solidify to adequately improve the thermal storage efficiency.

### SUMMARY OF THE INVENTION

In view of the above state of the art, the present invention has for its object to provide a thermal storage medium, which has high fluidity at a thermal storage temperature, is improved in heat transfer performance and further has excellent stability as a dispersion, and a process for producing such a thermal storage medium. Further, it is an object of the present invention to provide a thermal storage apparatus and a thermal storage system which can be suitably used for the purpose of saving and increasing efficiency of air conditioning energy, and of environmental protection.

As a result of intensive research on a thermal storage medium using an oil substance having a thermal storing property by phase change, the present inventors noted that one obtained by dispersing an oil substance in an aqueous medium has high level of safety and can be widely used to various heat storage systems, and have found that one obtained by dispersing, in an emulsion form, the oil substance having thermal storing property by phase change in the aqueous medium with a dispersant is suitable as the thermal storage medium. The present inventors have also found that, when the change in a volume average particle diameter of the dispersion falls within a specific range in the case where the operation of solidification/melting by phase change is repeatedly conducted on the dispersion of the oil substance, the dispersion can be favorably used for the purpose of saving and increasing efficiency of air conditioning energy and environmental protection, and therefore reached the present invention.

In the emulsion type thermal storage medium obtained by dispersing the oil substance having the thermal storing property by phase change in water according to the present invention, a surfactant as a dispersant is appropriately selected and used in order to prevent the emulsion from breaking (separation into the oil substance and water) due to a repetition of solidification/melting based on the phase change of the thermal storage medium and in order to use the thermal storage medium in a stable condition over an extended time period.

Therefore, the present invention is a thermal storage medium obtained by dispersing, in an oil-in-water manner, a mixture comprising an oil substance having a thermal storing property by phase change, an aqueous medium and a dispersant, wherein an amount of change in a volume average particle diameter of a dispersion of said oil substance after carrying out a 50 times of repetition of solidification/melting by phase change is within ±50% relative to a volume average particle diameter before carrying out the repetition of solidification/melting.

The present invention is also directed to a process for producing the above thermal storage medium, which comprises subjecting the thermal storage medium to phase change and then re-dispersing the same, said thermal storage medium being obtained by dispersing, in an oil-in-water manner, a mixture comprising said oil substance, said aqueous medium and said dispersant.

The present invention is further directed to a process for producing the above thermal storage medium, which comprises a step of dispersing said oil substance by using a line mixer.

The present invention is further directed to a process for producing the above thermal storage medium, which comprises subjecting the thermal storage medium to phase change and then re-dispersing the same by using a static mixer, said thermal storage medium being obtained by dispersing, in an oil-in-water manner, a mixture comprising said oil substance, said aqueous medium and said dispersant.

The present invention is also directed to a thermal storage apparatus or a thermal storage system, which is obtained by using the above thermal storage medium or a thermal storage medium produced by the above process for producing the thermal storage medium.

### DETAILED DESCRIPTION OF THE INVENTION

The present invention is now described in detail.

The thermal storage medium of the present invention is a substance which contains a dispersion obtained by dispersing, in an oil-in-water manner, a mixture comprising an oil substance having thermal storing ability by phase change, an aqueous medium and a dispersant and is in such form that, when a repetition of solidification/melting based on phase change is conducted 50 times on the dispersion of the oil substance, the amount of change in a volume average particle diameter of the dispersion is within ±50% relative to the volume average particle diameter before carrying out the repetition of solidification/melting.

The thermal storage medium of the present invention in the above aspect is the thermal storage medium containing the dispersion containing, as essential components, the oil substance having the thermal storing property by phase change, the aqueous medium and the dispersant, and is one, in which the change in a volume average particle diameter after a repetition of solidification/melting by phase change of the oil substance is specified. The above repetition of solidification/melting means the repetitive operation of storing heat in the oil substance having the thermal storing property by phase change in the form of latent heat and releasing the stored heat is conducted repeatedly.

In the present invention, the change in the volume average particle diameter of the dispersion after 50 times operation of solidification/melting repetition by phase change of the oil substance falls within ±50% as compare to that before the operation of the repetition; and as a preferable aspect of the invention, one having the change in the volume average particle diameter of within the above-mentioned range when number of repetition of solidification/melting by phase change of the oil substance having the thermal storage property is 100 times or more, and more preferably, the number of repetition is 200 times or more. Regarding the repetition of solidification/melting of the oil substance, the smaller the change in the volume average particle diameter of the dispersion, the less a break of the oil substance in the dispersion becomes; therefore it can be used stably over an extended time period.

As for a test of the repetition of solidification/melting by phase change of the above oil substance, it is preferable to charge the thermal storage medium in a sample bottle and carry out a cycle test at a temperature at which the repetition of solidification/melting by phase change can be conducted. For example, when pentadecane having a melting point of 10° C. is used as the oil substance, the solidification by phase change can be carried out by adjusting a temperature of the thermal storage medium to 5 to 7° C. When the melting is to be conducted thereafter, it can be carried out by adjusting the thermal storage medium to 12 to 15° C.

The above amount of change (%) in the volume average particle diameter is determined by the following formula: Amount of change in the volume average particle diameter (%)=(volume average particle diameter before operation of solidification/melting repetition−volume average particle diameter after operation of 50 times repetition of solidification/melting)/(volume average particle diameter before operation of solidification/melting repetition)×100.

The volume average particle diameter is measured by using Laser Diffraction Particle Size Analyzer SALD-3000 manufactured by Shimadzu Corp. The deionized water is used as a measuring medium.

The thermal storage medium of the present invention is preferably in an aspect in which a concentration of the dispersant in a dispersant aqueous solution comprising the aqueous medium and the dispersant at a thermal storage temperature is 0.01 to 4 times as compared to a saturated concentration of the dispersant.

The thermal storage medium of the present invention in such a preferred embodiment is one obtained by dispersing the oil substance having the thermal storing property through phase change in the aqueous medium by means of the dispersant, the usage amount of the dispersant being specified.

In the present invention, when the aqueous solution of the dispersant is formed with the aqueous medium and the dispersant, both of which constitute the thermal storage medium, in order to identify the usage amount of the dispersant, the concentration of the dispersant is calculated with using the concentration of the dispersant in a saturated solution of the aqueous solution of the dispersant at the thermal storage temperature as a standard. For example, when the dispersant, of which the saturated concentration at the thermal storage temperature is 30% by mass, is used, the concentration of the dispersant is 0.1 times relative to the saturated concentration in case of that the usage amount of the dispersant is 3% by mass.

The usage amount of the dispersant is set such that the dispersant concentration of the dispersant aqueous solution at the thermal storage temperature is 0.01 to 4 times when the concentration of the dispersant of the saturated solution at the thermal storage temperature of the dispersant aqueous solution is regarded as a standard.

The saturated solution means a solution in which the dispersant is dissolved in the maximum amount which can be solubilized in the aqueous medium, and the saturated concentration represents the content of the dispersant in the dispersant aqueous solution as the saturated solution by % by mass. The saturated solution according to the present invention also includes a solution in which the dispersant is dissolved in the maximum amount without producing gelation (a case where the fluidity is lost) before reaching the saturation in case that the dispersant is dissolved in the aqueous medium.

The above thermal storage temperature represents a temperature range of the thermal storage medium between a temperature to be used for storing heat in the oil substance having the thermal storing property by phase change and a temperature to be used for releasing the heat. Regarding the thermal storage medium of the present invention, the dispersant is used in such a way that the dispersant concentration falls within a range of 0.01 to 4 times relative to a saturated concentration of the dispersant in the whole range of temperature of the thermal storage medium to be used.

When the above-mentioned dispersant concentration is less than 0.01 times relative to the saturated concentration, the oil substance having the thermal storing property by phase change cannot be sufficiently dispersed, and when the dispersant concentration exceeds 4 times, the dispersant is separated to be not concerned in formation of oil droplets, and therefore the stability of the emulsion may possibly decrease.

As the preferred embodiment of the present invention, the dispersant concentration is 0.01 to 1 time relative to the saturated concentration. Thereby, it becomes possible to suppress the decrease in heat transfer performance due to the reduction of fluidity in a region of the thermal storage temperature or increase in load on a circulating pump transferring the emulsion, whereby the effect of the present invention can be exhibited to more sufficient extent. This concentration is more preferably not less than 0.05 time and not more than 1 time, still more preferably not less than 0.1 time and not more than 0.5 time relative to the saturated concentration.

In case that the dispersant which has a solubility in the aqueous medium is used, fluidity in a region of the thermal storage temperature is decreased when the emulsion is prepared by adding the dispersant in much excess amount than the saturated concentration, and therefore such problems occur that heat transfer performance is degraded or that the load on a circulating pump transferring the emulsion increases. When the concentration of the dispersant is lower than the saturated concentration at the time of preparing the emulsion but it extensively exceeds the saturated concentration in the region of the thermal storage temperature, the dispersant forming the oil droplets is detached and migrate to water side, thereby is separated and is not concerned in formation of oil droplets and it results in reduction in the stability of the emulsion. In accordance with the thermal storage medium of the present invention, the above-mentioned problems are resolved and the durable emulsion can be obtained by dissolving the dispersant in a specified range of the concentration and using the same.

The thermal storage medium of the present invention is preferably the substance which contains a oil-in-water dispersion for thermal storage comprising the above-mentioned oil substance having the thermal storing property by phase change, the above-mentioned aqueous medium and the above-mentioned dispersant, while the viscosity of the dispersion is 5 to 2,000 mPa·s at 4° C. when the content of the oil substance in the dispersion is set to 50% by mass.

While in the present invention, a preferable configuration is a substance in which the viscosity of the dispersion is 5 to 2,000 mPa·s at 4° C. when the content of the oil substance in the dispersion is 50% by mass, however, a more preferable configuration is a substance in which the viscosity of the dispersion is 5 to 1,000 mPa·s, and still more preferably, the viscosity is 5 to 500 mPa·s. When the viscosity exceeds 2,000 mPa·s, the fluidity is decreased and the load may be generated on a pump transferring the thermal storage medium. There is also a possibility that heat conductivity decreases due to the increased viscosity. When the viscosity is set to less than 5 mPa·s, it is necessary to adjust the content of the oil substance contained in the dispersion so as to be less than 50% by mass. Decrease in the amount of the oil substance causes the amount of stored heat to decrease and therefore the performance as the thermal storage medium is degraded, and this also becomes an unfavorable configuration of the thermal storage medium.

In the present invention, the viscosity is measured at 4° C. using a viscometer of B8L type (manufactured by Tokimec Inc.).

The thermal storage medium of the present invention is preferably one which comprises an oil-in-water dispersion for thermal storage containing the above-mentioned oil substance having the thermal storing property by phase change, the above-mentioned aqueous medium and the above-mentioned dispersant, and in which in the oil-in-water dispersion for thermal storage containing the oil substance having the thermal storing property by phase change, the aqueous medium and the dispersant, the viscosity of the dispersion is 5 to 2,000 mPa·s at 4° C. when the content of the oil substance in the dispersion is set to 50% by mass after the phase change of solidification/melting is conducted on the oil substance of the dispersion. Even when the phase change of solidification/melting is conducted on the oil substance, the dispersibility of the oil substance is enhanced and fluidity is improved so that the heat transfer performance is improved if the viscosity is 5 to 2,000 mPa·s.

The thermal storage medium of the present invention according to the above aspect is the oil-in-water dispersion for thermal storage comprising the oil substance having the thermal storing property by phase change, the aqueous medium and the dispersant, and in which the viscosity after the phase change of solidification/melting on the oil substance is identified. The phase change of solidification/melting means to carry out the operation of storing heat in the oil substance having the thermal storing property by phase change in the form of latent heat and releasing the stored heat, and this includes the case where the solidification/melting is conducted only one time, in the present invention.

The phase change of solidification/melting of the oil substance described above can be implemented by using a method similar to that described with respect to the above-mentioned the test of repetition of solidification/melting. And, this can also be implemented in a thermal storage water tank for storing the thermal storage medium, pipings for transferring the thermal storage medium, or a heat exchanger, all of which are installed in the thermal storage apparatus or the thermal storage system.

The above phase change of solidification/melting of the oil substance may be carried out repeatedly. The number of repetition of the phase change by solidification/melting of the oil substance having the thermal storage property is preferably 50 times or more, and more preferably 100 times or more. In the repetition of the phase change of the oil substance, the smaller the change in viscosity by degradation of the thermal storage medium, the longer the time period becomes, over which the oil substance can be used stably.

The thermal storage medium of the present invention is preferably used under contact with or in the presence of metal. The dispersion obtained by dispersing in the aqueous medium is usually considered to become unstable due to degradation of surface-active ability when metal exists in the case where the dispersion is stabilized in the form of emulsion by means of the surfactant, but in the aspect of the dispersion comprising the oil substance having the thermal storing property by phase change in accordance with the present invention, it is stabilized under contact with metal and/or in the presence of metal.

The above thermal storage medium is preferably in such aspect that, for example, the metal is contained in the aqueous medium and/or the dispersion by being used in the pipings and the heat exchangers constituted by metal parts. More preferably, the thermal storage medium is used in the thermal storage apparatus or in the thermal storage system. In the thermal storage system, the thermal storage apparatus in which the thermal storage medium is stored, heat exchangers and the pipings for the circulation between the heat exchangers are provided. It is preferable to constitute the piping and the heat exchanger, with which the thermal storage medium contacts, with metal parts of iron, copper, stainless steel, zinc, aluminum or the like and to use the thermal storage medium in contact with these metals to thereby obtain such an aspect that the metal is contained in the aqueous medium and/or the dispersion. The existence amount of the above-mentioned metal is, for example, preferably 1 ppm or more and more preferably 100 ppm or more, and preferably 5,000 ppm or less.

In the oil-in-water dispersion for thermal storage comprising the oil substance having the thermal storing property by phase change, the aqueous medium and the dispersant, the present invention is preferably such that the viscosity of the dispersion is 5 to 2,000 mPa·s at 4° C. when the content of the oil substance in the dispersion is set to 50% by mass after carrying out the phase change of solidification/melting on the oil substance of the dispersion under contact with metal parts utilized in the thermal storage system. By doing so, it becomes possible to enhance the dispersibility of the oil substance and improve the fluidity to further improve the heat transfer performance.

As the thermal storage medium of the present invention, a cloud point of the dispersant is preferably higher than the thermal storage temperature. For example, when the dispersant comprises a nonionic surfactant as an essential component, the dispersant aqueous solution is formed from the aqueous medium and the dispersant, both of which constitute the thermal storage medium, and in this case, it is preferable that the cloud point of the dispersant is set so as to be higher than the thermal storage temperature according to the present invention. The cloud point means a temperature at which a clear aqueous solution of a nonionic surfactant begins to be cloudy with increasing the temperature of the aqueous solution. When the nonionic surfactant is uses as an emulsifier, it is important that the region of the thermal storage temperature is not higher than the cloud point. Thereby, the degradation of the stability of the emulsion due to the separation of the dispersant in the region of the thermal storage temperature where the thermal storage medium is used is suppressed, and the fluidity of the thermal storage medium is improved, and therefore it becomes possible to improve the heat transfer performance of the thermal storage medium or to further reduce the load on a circulating pump transferring the thermal storage medium. In this case, preferably, the cloud point of the dispersant aqueous solution is higher than the thermal storage temperature by 5° C. or more, and more preferably, by 10° C. or more.

It is preferable that the thermal storage medium of the present invention does not include a crosslinked gel body containing the oil substance having the thermal storing property by phase change or a substance encapsulated in a capsule shell. By not including such the crosslinked gel body of the oil substance or the substance encapsulated in the capsule shell, the fluidity of the thermal storage medium in the thermal storage temperature region is further enhanced, and thereby it becomes possible to improve the heat transfer performance of the thermal storage medium or to further reduce the load on a circulating pump transferring the thermal storage medium.

The above-mentioned crosslinked gel body containing the oil substance having the thermal storing property by phase change includes a substance in which the oil substance is retained inside of lipophilic polymer particles, namely, a substance obtained by adding a mixed solution of the oil substance having the thermal storing property by phase change and the monomer component including a crosslinkable monomer to an aqueous solution containing the dispersant, and polymerizing the mixture. The substance encapsulated in the capsule shell includes substances obtained by such methods as an encapsulation technique based on a composite emulsion technique, a method of spraying thermoplastic resin onto the surface of the thermal storage material particles, a method of forming thermoplastic resin on the surface of the thermal storage material particles in liquid, a method of polymerizing a monomer on the surfaces of the thermal storage material particles and coating, and a process of producing a micro capsule having a polyamide shell based on a interfacial polycondensation reaction.

The oil substance having the thermal storing property by phase change, the aqueous medium and the dispersant which constitute the thermal storage medium of the present invention are now described.

The oil substance of the present invention has the thermal storing property by phase change. Namely, it has the latent heat thermal storage, which utilizes latent heat upon phase change or phase transition, as the thermal storing property, has a high thermal storage density and can storage and release heat in the vicinity of the definite temperature. Thereby, It becomes possible to store and release the heat energy such as sensible heat thermal storage, latent heat thermal storage and chemical reaction thermal storage.

As the component constituting the above oil substance, hydrocarbon compounds such as paraffin and α-olefin; higher fatty acids; higher fatty acid esters; higher alcohols and the like compounds are suitable, and specifically, medium paraffins which are in liquid form at ordinary temperature such as C₁₄ paraffin, C₁₅ paraffin and C₁₆ paraffin; higher paraffins which are in solid form at ordinary temperature such as C₁₇ paraffin, C₁₈ paraffin, C₁₉ paraffin, C₂₀ paraffin, C₂₁ paraffin, C₂₂ paraffin, C₂₃ paraffin, C₂₄ paraffin and C₂₅ paraffin; and higher alcohols such as 1-decanol are suitable. Among these, because of their convenience in handling, in the case of the thermal storage medium for building air conditioning, it is preferable to use a substance which is liquid at ordinary temperature (25° C.) and at normal atmospheric pressure (about 101.3 kPa) as the component constituting the oil substance having the thermal storing property by phase change. Further, because these are readily available and can simply and stably produce the thermal storage medium applicable to a wide range of temperature, paraffins are preferable and in case of applications of heating/cooling for building air conditioning and the like, pentadecane is preferably included among paraffins.

As the above oil substance, a single component maybe used, however, the melting point thereof can be adjusted to the thermal storage temperature to be used by arbitrarily adjusting species and a formulating ratio of the oil substance having the thermal storing property by phase change. When to be used for cooling applications, an oil substance having the thermal storing property by phase change and having a melting point of about 5 to 20° C. may be selected. When to be used for heating applications, an oil substance having the thermal storing property by phase change and having a melting point of about 40 to 60° C. may be selected.

The oil substance constituting the thermal storage medium of the present invention is preferably (1) one comprising three or more components and having a variance of a mass fraction of each component of not less than 0.3 and not more than 0.5, or (2) one comprising two or more components and having a variance of a mass fraction of each component of not less than 0.9 and less than 1.0. The variance of the mass fraction of each component is preferably not less than 0.35 and not more than 0.45 for the case (1), and not less than 0.920 and not more than 0.998 for the case (2).

The above variance (V) of the mass fraction of each component is a value determined by the following equation:

$$V = \frac{n Σ {x}^{2} - {( Σ x )}^{2}}{n ( n - 1 )} \times n$$

In the above equation, n represents number of components constituting the oil substance and x represents a mass fraction of each component with the total mass of the oil substance being taken as 1.

When a variance (V) determined from the above equation is 0, this means that all components constituting the oil substance are identical in an amount and when the variance (V) is 1.0, this means that the component constituting the oil substance is a single component (one component constitutes 100% of the oil substance).

Further, in a function (VAR) in which an argument is regarded as a specimen from a mother population and in which a variance relative to the mother population is determined, the variance is calculated by the following equation:

$$VAR = \frac{n Σ {x}^{2} - {( Σ x )}^{2}}{n ( n - 1 )}$$

In the above equation, n and x are the same as those described above.

In the present invention, in order to bring the variance to 1.0 for the case being nul in the variance (one component constitutes 100% of the oil substance) and 0 for the case of maximum variance (all components constituting the oil substance are identical in an amount) irrespective of number of components constituting the oil substance, the variance is brought to a value of 0 to 1.0 by multiplying the equation of VAR function by number of components n. Therefore, the equation of the variance (V) of the mass fraction of each component is obtained by multiplying the equation of VAR function by number of components n.

In the aspect of the above (1), three or more of components constituting the above oil substance, and in the aspect of the above (2), two or more of these components are used in combination. In the present invention, one compound constitutes one component, and for example, when the respective paraffins have the same carbon atoms and contain isomers such as a normal paraffin or a branched paraffin, each paraffin is regarded as one component.

As the oil substance in the above aspect (1), it is preferable that a substance containing three or more components and that each component is a homolog of the hydrocarbon compound because of low cost, easy availability and easy controllability of phase transition temperature. For example, in the case of applications of heat of air conditioning, a mixture of C₁₄ paraffin, C₁₅ paraffin and a paraffin having 16 or more carbon atoms; and a mixture of C₁₄ paraffin, C₁₆ paraffin and C₁₈ paraffin are preferable. As a mass fraction of these, in case of the mixture of C₁₄ paraffin, C₁₅ paraffin and a paraffin having 16 or more carbon atoms, it is preferable that C₁₄ paraffin: C₁₅ paraffin: a paraffin having 16 or more carbon atoms=0.2 to 30:50 to 80:2 to 20; and in case of the mixture of C₁₄-paraffin, C₁₆ paraffin and C₁₈ paraffin, it is preferable that C₁₄ paraffin: C₁₆ paraffin: C₁₈ paraffin=0.2 to 40:50 to 60:2 to 10. The oil substance constituted by such components is one of the preferred embodiments of the present invention.

The oil substance of the above aspect (2) is preferably one which comprises at least one species of hydrocarbon compound selected from the group consisting of compounds having 14, 15, 17 and 19 carbon atoms as a main component. More preferably, it is one comprising hydrocarbon compounds having 14 and/or 15 carbon atoms as main components. It is also preferred that the hydrocarbon compound is a paraffin. The “main component” means a component which constitutes 50% by mass or more with all components constituting the oil substance being taken as 100% by mass. The main component may be composed of one component, or two or more components. When the main component is composed of two or more components, sum total of the respective components constituting the main component may be 50% by mass or more.

A usage amount of the above oil substance may be appropriately selected depending on a species of the oil substance having the thermal storing property by phase change, a usage form of the thermal storage medium and a required thermal storage efficiency, and preferably, it is 10% by mass or more and less than 100% by mass in the thermal storage medium of 100% by mass. When it is less than 10% by mass, there is a possibility that the thermal storage efficiency and the thermal storing performance are degraded. More preferably, it is 20% by mass or more and 75% by mass or less.

A nucleating agent is preferably added to the above oil substance. As the nucleating agent, a substance which can become the crystal nucleus upon solidification of the thermal storage medium may be used, but it is preferably a substance similar in a crystal structure as the oil substance having the thermal storing property by phase change, and is preferably a substance which has a melting point higher than the oil substance and is solidified in an earlier step. Further, it is more preferably a substance having a phase transition temperature higher than a melting point of the oil substance by 10 to 100° C. Whether the melting point of the nucleating agent is less than 10° C. or exceeds 100° C. than the melting point of the oil substance, a function as the nucleating agent is detracted and alienation (supercooling phenomenon) between temperatures of solidifying/melting cannot been adequately prevented.

As the above-mentioned nucleating agent, there can be mentioned, is case that n-pentadecane is used as the oil substance having thermal storing property by phase change, saturated hydrocarbons such as n-heptadecane, n-octadecane, n-nonadecane, n-eicosane, n-docosane, n-tricosane, n-tetracosane, n-pentacosane; unsaturated hydrocarbons such as 1-octadecene; higher fatty acids such as stearic acid; higher alcohols such as octadecanol; sorbitan fatty acid esters such as sorbitan tristearate; polyoxyethylene sorbitan esters such as polyoxyethylene sorbitan tristearate; sucrose fatty acid esters such as sucrose stearate; glycerin fatty acid esters such as tristearin; and fatty acid amides such as stearamide. Among them, sucrose fatty acid esters and saturated hydrocarbons are preferable. These nucleating agents maybe used in combination of two or more species, where necessary.

The amount of addition of the above nucleating agent is preferably not less than 0.5% by mass and not more than 20% by mass relative to the oil substance of 100% by mass. If it is less than 0.5% by mass, supercooling cannot be adequately prevented, and if it exceeds 20% by mass, a thermal storage efficiency cannot be adequately improved because the content of the oil substance having the thermal storing property in the thermal storage medium is reduced. More preferably, it is not less than 1% by mass and not more than 10% by mass.

In the thermal storage medium of the present invention, the aqueous medium is one contains water as an essential component, however, a mixture of water and a solvent soluble in water can be used; for example, mixed solvents of water with methanol, ethanol, isopropyl alcohol, acetone, acetonitrile, ethyleneglycol and diethyleneglycol are suitable. The proportion of water in the aqueous medium is preferably not less than 50% by mass, and more preferably not less than 80% by mass. Still more preferably, only water is used.

The usage amount of the above aqueous medium is preferably not less than 5.0% by mass and not more than 900% by mass relative to the oil substance having the thermal storing property by phase change of 100% by mass.

The dispersant in the present invention is preferably one comprising a nonionic surfactant as an essential component, and as the nonionic surfactant, sorbitan ester compounds such as polyoxyalkylene sorbitan alkyl ester and sorbitan alkyl ester; sucrose fatty acid ester; polyoxyethylene alkyl ether; polyoxyethylene alkyl phenol ether; polyoxyethylene alkyl ester; polyglycerin alkyl ester; fatty acid ester; fatty acid soap; alkylamine-ethylene oxide adduct; and sterols such as cholesterol are suitable. Each of them may be used alone, or two or more species may be used in combination. Among these, it is preferably one comprising polyoxyethylene (the average molar number of addition of ethylene oxide is not less than 20) alkyl (total number of carbon atoms is not less than 15) ether as an essential component. As for such essential component, the average molar number of addition of ethylene oxide is not less than 20 and preferably not more than 100, and more preferably not more than 50. The total number of carbon atoms is not less than 15 and preferably not more than 40, and more preferably not more than 30.

Among these, polyoxyethylene stearyl ether in which the average molar number of addition of ethylene oxide is not less than 20 is more preferable.

As the above dispersant, an amphoteric surfactant, an anionic surfactant, a nonionic-anionic surfactant and cationic surfactant may be appropriately used. As these surfactants, alkyl sulfates such as sodium alkylsulfonate; alkylbenzene sulfonic acids and salts thereof such as sodium alkylbenzene sulfonate; alkyl (phenyl) ether sulfates such as sodium polyoxyethylene lauryl ether sulfate; α-olefin sulfonates such as sodium tetradecene sulfonate; sulfosuccinates; ether sulfonates; ether carboxylic acid and salts thereof; betaines such as lauryl amidopropyl betaine; and quaternary ammonium such as dialkyl ammonium chloride are preferable.

As the dispersant described above, a polymer dispersant described later is preferably used in combination with the above-mentioned surfactant.

These dispersants can be appropriately used as long as the amount of change in the volume average particle diameter of the dispersion, as described above, falls within the above specified preferable range when these are blended.

In the present invention, the above dispersant comprises the surfactant, and preferably, the above surfactant comprises one having an index of hydrophile-lipophile balance of less than 12 and one having an index of hydrophile-lipophile balance of not less than 12 as essential. More preferably, it comprises one having the index of less than 9 and one having an index of not less than 12 as essential. Still more preferably, it comprises one having the index of less than 3 and one having not less than 12 as essential. In this case, supercooling is more effectively prevented than the case of using single surfactant by a synergistic effect produced by combining substances being low and high in the index of hydrophile-lipophile balance and therefore solidification becomes easy to improve the thermal storage efficiency.

The index of hydrophile-lipophile balance represents a balance between a hydrophilic portion and a lipophilic portion of the surfactant and is usually referred to as HLB (hydrophile-lipophile balance). The surfactant having a large value of this index is high in hydrophilicity.

The HLB of the surfactant of which a molecular structure is apparent can be determined by Griffin Equation or Davies Equation. For the surfactant of which a molecular structure is not apparent, HLB can be experimentally determined by conducting an emulsifying test using the oil substance and the surfactant both of which HLB values are known.

The surfactant in the present invention is to contain at least one species of the surfactant having the index of hydrophile-lipophile balance of less than 12 and at least one species of the surfactant having the index of hydrophile-lipophile balance of not less than 12, and it is preferable that the index of hydrophile-lipophile balance of whole surfactant, which can be determined from the mass fraction of each surfactant constituting the surfactant of the present invention, is not less than 5 but not more than 15. When it is less than 5, there is a possibility that stability of the emulsion is degraded, and when it exceeds 15, there is a possibility that supercooling cannot be prevented. More preferably, it is not less than 5 and not more than 12, and still more preferably, not more than 11.

The above-mentioned index of hydrophile-lipophile balance of whole surfactant is determined by the following equation;

Σ(Xi×HXi)+Σ(Yj×HYj): addition is made from 1 to ni with respect to i and from 1 to nj with respect to j.

In this equation, the index of hydrophile-lipophile balance of whole surfactant is determined by the sum of the values obtained by multiplying the mass fractions by the index of hydrophile-lipophile balance of the respective surfactants constituting the surfactant.

In the above equation, Xi is a mass fraction of a surfactant i having the index of hydrophile-lipophile balance of less than 12 where the mass of whole surfactant is regarded as 1 and Yj is a mass fraction of a surfactant j having the index of hydrophile-lipophile balance of not less than 12 where the mass of whole surfactant is regarded as 1, and HXi is the index of hydrophile-lipophile balance of the surfactant i having the index of hydrophile-lipophile balance of less than 12 and HYj is the index of hydrophile-lipophile balance of the surfactant j having the index of hydrophile-lipophile balance of not less than 12. In the above equation, i and j are the numbers of the surfactant to be used in the present invention, and the number of the surfactant varies with kinds of surfactant. Further, i and j are integers from 1 to n₁ and from 1 to n₂, respectively, and n₁ represents total number of species of the surfactant having the index of hydrophile-lipophile balance of less than 12 and n₂ represents total number of species of the surfactant having the index of hydrophile-lipophile balance of not less than 12.

As the surfactant used in the thermal storage medium of the present invention, the nonionic surfactants are preferably used as described above and among the above nonionic surfactants, sorbitan alkyl ester and/or sucrose fatty acid ester is preferably used as the surfactant with HLB of less than 12. As the nonionic surfactant with HLB of not less than 12, polyoxyalkylene sorbitan alkyl esters and/or polyoxyethylene alkyl ethers are preferable. Among them, polyoxyethylene (the average molar number of addition of ethylene oxide is not less than 20) sorbitan alkyl (total number of carbon atoms is not less than 15) esters and/or polyoxyethylene (the average molar number of addition of ethylene oxide is not less than 20) alkyl (total number of carbon atoms is not less than 15) ethers are more preferable.

The usage amount of the above surfactant is appropriately selected so as to allow the amount of change in the volume average particle diameter to fall within the preferred range as described above, however, the amount is preferably not less than 0.1% by mass and not more than 30% by mass relative to the oil substance of 100% by mass. More preferably, it is not less than 1.0% by mass and not more than 20% by mass.

The usage amount of the above surfactant having an index of hydrophile-lipophile balance of less than 12 is preferably not less than 5.0% by mass and not more than 95% by mass relative to the surfactant of 100% by mass. More preferably, it is not less than 10% by mass and not more than 50% by mass. The usage amount of the above surfactant having the index of hydrophile-lipophile balance of not less than 12 is preferably not less than 5.0% by mass and not more than 95% by mass relative to the surfactant of 100% by mass. More preferably, it is not less than 50% by mass and not more than 90% by mass.

The thermal storage medium of the present invention preferably contains the dispersion obtained by dispersing the oil substance having the thermal storing property by phase change in the aqueous medium by using a polymer dispersant together with the surfactant as essential components. By using the polymer dispersant together with the surfactant as the dispersant, the stability of the emulsion can be adequately improved because of a synergistic effect of these.

Further, in the present invention, with respect to these raw materials to constitute the thermal storage medium, one species may be used, or two or more species may be used in combination.

The polymer dispersant according to the present invention is not specifically limited as long as it is a polymer substance which is easy to be wet to water or easy to be dissolved in water. For example, polyvinyl alcohol, polyvinyl pyrrolidone, polyacrylamide, polyvinyl methyl ether, polyethylene oxide, polypropylene oxide, (meth)acrylic ester copolymer, (meth)acrylic acid-(meth)acrylic ester copolymer, methyl cellulose, methylhydroxypropyl cellulose, hydroxypropylmethyl cellulose, hydroxyethyl cellulose, hydroxypropyl cellulose, soluble starch, dextrin, gum arabic, chitosan, agar, gelatin, soybean casein, poly(acrylic acid), sodium polyacrylate, acrylic acid-acrylic ester copolymer, sodium acrylate-sodium maleate copolymer, polymaleic acid, polyvinyl sulfonic acid, sodium polystyrene sulfonate, sodium carboxymethyl cellulose, polyethylene imine, polydiallylamine, polyallylamine, poly N-vinylformaldehyde, polyvinylamine, and polyamidine are suitable. In the polymer dispersant which is easily dissolved in water, it is preferred that when it is dissolved in water at 25° C., 80% by mass or more thereof is dissolved.

Among them, as a nonionic polymer dispersant, a polymer dispersant having a weight average molecular weight of 5,000 to 300,000 is preferable and a polymer dispersant having that of 50,000 to 200,000 is more preferable; as the nonionic polymer dispersant having such a weight average molecular weight, polyvinyl alcohol, polyvinyl pyrrolidone, hydroxypropylmethyl cellulose and the like are preferable. As an ionic polymer dispersant, a polymer dispersant having a weight average molecular weight of 5,000 to 3,000,000 is preferable and a polymer dispersant having a weight average molecular weight of 50,000 to 3,000,000 is more preferable, and still more preferably 100,000 to 2,000,000; as the ionic polymer dispersant having such a weight average molecular weight, sodium polyacrylate is preferable.

The usage amount of the above polymer dispersant is preferably 0.001% by mass or more and 5% by mass or less relative to the oil substance having the thermal storing property by phase change of 100% by mass. More preferably, it is 0.01% by mass or more and 3% by mass or less relative to the oil substance of 100% by mass.

According to the present invention, when the dispersant nonionic surfactant is used as an essential component, the nonionic surfactant may be used alone, however, the nonionic surfactant may be used in combination with another dispersant, as described above. As a specific example of the combined use, there can be mentioned the combined uses of the nonionic surfactant and anionic surfactant, the nonionic surfactant and cationic surfactant, the nonionic surfactant and nonionic-anionic surfactant, the nonionic surfactant and amphoteric surfactant, the nonionic surfactant and polymer dispersant, the nonionic surfactant and anionic surfactant and the polymer dispersant, the nonionic surfactant and cationic surfactant and the polymer dispersant, and the like.

The thermal storage medium of the present invention may also further contain additives having the functions described below. These additives maybe used alone or two or more species may be used in combination.

(1) For improvement of heat transfer: metal powder of iron, copper and the like; metal fiber; metal oxide; carbon; carbon fiber, etc.

(2) For adjustment of specific gravity: sand; clay; stone; metal powder of lead, iron and the like.

(3) For imparting flame retardant properties: water; water gel; metal powder; inorganic compounds such as calcium carbonate; bromic, chloric and phosphoric fire retardant, etc. Here, flame retardant properties include reduction of combustibility, prevention of the spread of fire, extinction of flash point by steam, effect for reduction of the amount of heat from combustion and the like.

(4) For prevention of supercooling: metal powder, high polymer paraffin (wax), etc.

(5) For adjustment of solidifying point: waxes, etc.

(6) For antioxidation and prevention of deterioration with the lapse of time: phenolic, thio and phosphoric antioxidants, etc.

(7) Others: colorant, pigment, anti static agent, antiseptics and the like.

The usage amount of the above-mentioned additives is preferably 10 to 40% by mass relative to the oil substance having the thermal storing property by phase change, for example, when calcium carbonate is used for prevention of the spread of fire.

Clathrate compounds maybe added to the above oil substance in order to adjust the latent heat property. As the above clathrate compounds, C₄H₈.O.17H₂O, (CH₃)₃N.10.25H₂O, (C₄H₉)₄NCHO₂.32H₂O, and (C₄H₉)₄NCH₃CO₂.32H₂O are suitable. These compounds may be used alone or two or more species may be used in combination.

The thermal storage medium of the present invention is preferably produced, for example, by a method of adding the oil substance having the thermal storing property by phase change to an aqueous solution obtained by dissolving the dispersant in an aqueous medium and emulsifying the mixture by agitation, or a method of adding the oil substance having the thermal storing property by phase change in which the surfactant is dissolved to an aqueous solution obtained by dissolving the polymer dispersant in an aqueous medium and emulsifying the mixture by agitation and the like. Such a method of producing is one of the preferred embodiments of the present invention.

The thermal storage medium of the present invention is also preferably produced by a method which comprising subjecting, to phase change, the thermal storage medium obtained by dispersing, in an oil-in-water manner, a mixture comprising the nucleating agent, the oil substance having the thermal storing property by phase change, the aqueous medium and the dispersant and then re-dispersing it. Such a process for producing is also one of the preferred embodiments of the present invention.

The process for producing the thermal storage medium of the present invention is a method which comprises dispersing the mixture comprising the oil substance having the thermal storing property by phase change, the aqueous medium and the dispersant, in an oil-in-water manner to thereby produce the thermal storage medium, and the above process for producing the thermal storage medium comprises a step of dispersing the oil substance having the thermal storing property by phase change by using a line mixer.

In the process for producing the thermal storage medium of the present invention, the thermal storage medium obtained by dispersing a raw material for production which comprises the nucleating agent, the oil substance having the thermal storing property by phase change, the aqueous medium and the dispersant in an oil-in-water manner is used in the thermal storage apparatus and the like, to thereby conduct a repetition of solidification/melting by phase change and, thereafter, a step of re-dispersing thermal storage medium is included. Such step of re-dispersing includes an aspect in which the dispersed condition of the oil substance is maintained by agitating the thermal storage medium of the oil substance being already in the dispersed condition and an aspect in which the oil substance is adequately dispersed by re-dispersing the thermal storage medium of the oil substance being separated, and the process for producing of the present invention is applied to either of or the combination of these aspects.

In the process for producing the thermal storage medium of the present invention, there can be mentioned (1) an aspect of producing the dispersion of the oil substance from the raw material, (2) an aspect of maintaining the dispersed condition of the dispersion of the oil substance, and (3) an aspect of re-dispersing the broken dispersion in case that the dispersion of the oil substance is broken and separated into an oil phase and a water phase, and the process for producing of the present invention is applied to either of or the combination of these aspects.

In the present invention, the above-mentioned aspects are implemented in the step of dispersing the oil substance having the thermal storing property by phase change by using a line mixer. Therefore, the step of dispersing the oil substance is not only a step of obtaining the dispersion of the oil substance from the raw material by agitation using the line mixer, but also a step in which the dispersed condition of the oil substance is maintained by agitating the thermal storage medium of the oil substance being already in the dispersed condition with the line mixer, or in which the oil substance is adequately dispersed by re-dispersing the thermal storage medium of the oil substance being separated. As the thermal storage medium of the oil substance being adequately dispersed condition or the thermal storage medium of the oil substance being separated, the thermal storage medium obtained by the process for producing of the present invention or a thermal storage medium obtained by a production method other than the present invention may be used. In any of these aspects, the thermal storage medium is usually stored in a tank.

The line mixer according to the present invention does not directly agitate the raw material and the like in the tank but means a dispersing apparatus which conducts the dispersion by a baffle plate, a projection and mechanical agitation, which are provided in a way of the piping through which the raw material and the like in the tank passes.

The above line mixer includes a line mixer of the type that the mixer itself has a driving portion for agitation such as a motor or the like, which can disperse the oil substance having the thermal storing property by phase change and a line mixer of the type that the mixer itself does not have a driving portion for agitation. When the line mixer without having a driving portion for agitation is used, a circulating pump for transferring the raw material and the like is necessary.

As the above-mentioned line mixer of the type having a driving portion for agitation, one which has not only the capability as a mixer but also the pumping capability is suitable. In this case, a pump is not required to be provided in the piping, therefore, it is preferable in the point of simplification of the production facility, however, if the capability as a pump is insufficient, additional pump(s) may be provided. As such line mixer, there can be mentioned an inline mixer 450LS (manufactured by Silverson Machines, Inc.) and T. K. PIPELINE HOMOMIXER PL-2S (manufactured by Tokushu Kika Kogyo Co., Ltd.), which are provided with rotors rotative at a high speed. Such the line mixers agitate and disperse the raw material and the like by strong suction force, centrifugal force and shearing force obtained by high-speed rotation of rotors.

As the above line mixer of the type without having a driving portion for agitation, one which agitates by utilizing fluid flow generated by a pump or the like is suitable. As such line mixer, there can be mentioned a static type mixer OHR (Original Hydrodynamic Reaction) Line Mixer MX-8 (manufactured by Seika Corp.), Static Mixer (Noritake Co., Ltd.), BUNSANKUN (manufactured by Fujikin Inc.) and Line Mixer SMX, SMV (manufactured by Cork Gridge), etc. Such line mixers have elements having shapes of twisting a rectangular plate by an angle of 180 degree or impingement bodies in a shape of a mushroom in the line mixer, and agitate and disperse the raw material and the like by functions of these elements or impingement bodies.

The aspect of production in the present invention may be the configuration in which mixing is performed using the line mixer, and for example, the configuration in which a piping is connected to the tank to which a raw material and the like is charged and the line mixer is provided in a way of the piping is preferred. When the line mixer is provided, number to be provided and the locations to be provided may be appropriately selected according to a production scale, properties of the raw material, a velocity or a flow rate per unit period of the raw material passing through the piping, however, the line mixer is preferably located in the vicinity of the tank. Further, as for an aspect of supplying the raw material and the like to the line mixer, the mixture or the dispersion in the tank may be supplied to the line mixer through the piping, or the raw material may be supplied by connecting a piping for supplying each raw material to the line mixer.

In the aspect of production according to the present invention, when the line mixer is installed in a way of the piping, the mixture or the dispersion may be dispersed by passing them through the piping provided with the line mixer only one time, or passing them through two or more times. The mixture or the dispersion in the tank may be dispersed by circulating them through the piping provided with the line mixer.

In the present invention, it is preferred to circulate the mixture or the dispersion in the tank through the piping provided with the line mixer, and by doing so, it becomes possible to carry out a step of dispersing the oil substance simply and at low cost in any configuration of producing the dispersion of the oil substance, retaining the dispersed condition of the dispersion and re-dispersing the broken dispersion and the like.

The aspect of production in the present invention may be the configuration in which mixing is performed using the line mixer, and for example, the configuration in which a piping is connected to the tank to which a raw material and the like is charged and the line mixer is provided in a way of the piping is preferred. When the line mixer is provided, number to be provided and the locations to be provided may be appropriately selected according to a production scale, properties of the thermal storage medium, a velocity or a flow rate per unit period of the thermal storage medium or the like passing through the piping, however, the line mixer is preferably located in the vicinity of the tank. Further, as for an aspect of supplying the thermal storage medium or the like to the line mixer, the thermal storage medium in the tank may be supplied to the line mixer through the piping, or the thermal storage medium or the like may be supplied by connecting a plurality of piping to the line mixer.

The aspect of production of the present invention is now described in detail by means of drawings.

FIG. 1 is a schematic diagram representing an embodiment using a production apparatus 1 according to the process for producing of the present invention. This production apparatus 1 is constituted of a tank 2 for supplying the raw material and the thermal storage medium, a line mixer 3 which in itself has pumping capability, pipings 4 and 5 connected through the intermediary of the line mixer 3 and a draw off piping 6 of the obtained dispersion. The piping 4 is connected to the bottom of the tank 2 and leads to the line mixer 3. The piping 5 is connected to the line mixer 3 and leads to the tank 2. When the thermal storage medium is produced from the raw material in such production apparatus 1, the raw material is charged to the tank 2 and sent to the line mixer 3 through the piping 4 as the mixed solution. This mixed solution is dispersed by agitation in the line mixer 3 and returned to the tank 2 through the piping 5 as the dispersion. The dispersion returned to the tank 2 is agitated by convection and transferred again to the line mixer 3 through the piping 4. In such a production method, it becomes possible not only to produce the dispersion but also to maintain the dispersed condition of the dispersion by selecting a period of time of circulating the dispersion or by charging the thermal storage medium of the oil substance being already in the dispersed condition into the tank 2. When the oil substance is separated, it also becomes possible to re-disperse and retain the dispersion.

FIG. 2 is a schematic diagram representing one embodiment using a production apparatus 11 according to the process for producing of the present invention. This production apparatus 11 is constituted of a tank 12 for supplying the thermal storage medium, a line mixer 13 which in itself has pumping capability, pipings 14 and 15 connected through the intermediary of the line mixer 13 and a draw off piping 16 of the obtained dispersion. The piping 14 is connected to the bottom of the tank 12 and leads to the line mixer 13. The piping 15 is connected to the line mixer 13 and leads to the tank 12. When the thermal storage medium is re-dispersed in such production apparatus 11, it is subjected to phase change of the thermal storage medium in the tank 12, thereafter, transferred to the line mixer 13 through the piping 14. The thermal storage medium is dispersed by agitation in the line mixer 13 and returned to the tank 12 through the piping 15 as the dispersion. The dispersion returned to the tank 12 is transferred again to the line mixer 13 through the piping 14. In such a production method, the dispersed condition of the dispersion can be maintained by charging the thermal storage medium of the oil substance being already in the dispersed condition into the tank 12. When the oil substance is separated, it also becomes possible to re-disperse and retain the dispersion.

In the process for producing of the present invention, a dispersing means other than the line mixer may be additionally used if necessary, however, it is preferable to use only the line mixer as the dispersing means from the viewpoint of carrying out a step of dispersing the oil substance having the thermal storing property by phase change in the aqueous medium in a simple way and suppressing the investment cost. When another dispersing means is used, general machinery can be used. For example, there can be mentioned a propeller mixer, a high speed mixer, a homomixer, a high pressure homogenizer, a colloid mill, a roll mill, a roller mill, a sand mill, a ball mill, an ultrasonic emulsifier, a vacuum kneader, a vacuum emulsifier and an open type emulsifier, etc.

In the above-mentioned production of the thermal storage medium, re-dispersing may be carried out after conducting phase change of the thermal storage medium in the same water tank or dispersion tank as that has been used to obtain the thermal storage medium obtained by dispersing a mixture comprising the nucleating agent, the oil substance having the thermal storing property by phase change, the aqueous medium and the dispersant, in an oil-in-water manner. After drawing the thermal storage medium from the water tank or dispersion tank used to obtain the thermal storage medium dispersed in an oil-in-water manner, it may be charged into another water tank or dispersion tank to be used for the thermal storage system and the like, effected for phase change and then re-dispersed. Further, after effecting phase change of the thermal storage medium dispersed in an oil-in-water manner, re-dispersion may be carried out in the same water tank or dispersion tank, or after drawing the thermal storage medium from the water tank or dispersion tank, it may be charged into the other water tank or dispersion tank and re-dispersed.

The present invention is also a process for producing the thermal storage medium which comprises subjecting thermal storage medium, to phase change, obtained by dispersing, in an oil-in-water manner, a mixture comprising the oil substance having the thermal storing property by phase change, the aqueous medium and the dispersant as essential, and then re-dispersing the same using a static mixer.

The above-mentioned thermal storage medium obtained by dispersing, in the oil-in-water manner, a mixture comprising the oil substance having the thermal storing property by phase change, the aqueous medium and the dispersant as essential is preferably obtained by the process for producing of the present invention, but it is not specifically limited to this. In the process for producing described above, such a thermal storage medium is subjected to phase change by using the thermal storage apparatus and the like, and, therefore is re-dispersed using a static mixer.

The present invention is also preferably a method of producing the thermal storage medium comprising a dispersion obtained by dispersing the oil substance having the thermal storing property by phase change in the aqueous medium in the presence of the dispersant, which process for producing the thermal storage medium comprises a step of adjusting the usage amount of the dispersant based on the saturated concentration at the thermal storage temperature of the dispersant of the dispersant aqueous solution obtained by mixing the aqueous medium and the dispersant, the above concentration of the dispersant being 0.01 to 4 times relative to a saturated concentration of the dispersant aqueous solution. Such a process for producing is a preferred process for producing the thermal storage medium of the present invention.

Regarding the process for producing the thermal storage medium described above, as the method of preparing the oil substance having the thermal storing property by phase change in the form of water dispersion, a method of, for example, adding the oil substance having the thermal storing property by phase change to an aqueous solution in which the dispersant is dissolved and emulsifying the mixture by agitation is suitable. In this case, the step of adjusting the dispersant concentration of the above dispersant aqueous solution at the thermal storage temperature is conducted by identifying, as described above, the usage amount of the dispersant upon dissolving the dispersant in the aqueous medium such as water.

As a usage form of the thermal storage medium of the present invention, it is preferably used in the form of water dispersion such as emulsion, or it may be used as a thermal storage medium in the forma of filled in a packing material. Such thermal storage mediums are used in the region of the thermal storage temperature. Such thermal storage mediums are preferably stored in the thermal storage tank constituting the thermal storage apparatus and used.

In the present invention, the method of using the thermal storage medium in which the concentration of the dispersant at the thermal storage temperature of the dispersant aqueous solution is set within the above-mentioned thermal storage temperature region is one of the preferred embodiments of the present invention. The thermal storage temperature region may be set at a preferred temperature depending on usage conditions, for example, temperatures of 0 to 20° C. in using for cooling applications and 40 to 60° C. in using for heating applications.

The thermal storage medium of the present invention is used in various thermal storage apparatuses in an emulsion form or in a packed form, and as these thermal storage apparatuses, there can be mentioned (1) one in which the thermal storage medium works as a heat carrying medium to effect the heat exchange, and (2) one provided with the thermal storage tank in which the thermal storage medium is stored and being capable of carrying out the heat exchange of the heating medium.

As the thermal storage apparatus of the above (1), a thermal storage apparatus using the thermal storage medium dispersed in water is preferable, and a thermal storage apparatus which exchanges heat by circulating the thermal storage medium between the thermal storage tank and the heat exchanger or by circulating the same outside of the thermal storage tank can be mentioned; and the thermal storage system which is a system of a heat carrying medium for a district heating/cooling system or for a building air conditioning system is formed by such a thermal storage apparatus.

The thermal storage apparatus of the above (2) is one provided with the thermal storage tank in which the thermal storage medium is stored and thereby being able to carry out the heat exchange of the heating medium, however, the thermal storage apparatus in which the thermal storage medium is stored is preferable, and therefore the thermal storage system is also formed from such a thermal storage apparatus.

As the above-mentioned thermal storage apparatus in which the thermal storage medium is stored, a thermal storage apparatus which is provided with a heat exchange means in the thermal storage tank and thereby can give and receive the heat energy with the heating medium circulating outside of the thermal storage apparatus is favorable; for example, there can be mentioned one in which a heat exchanger carrying out the heat exchange of the heating medium is installed in the thermal storage tank where the thermal storage medium is stored, or one in which only the heating medium passes through the thermal storage tank while the water dispersion in an emulsion form remains in the thermal storage tank.

A thermal storage apparatus or thermal storage system using such thermal storage medium of the present invention is also one embodiment of the present invention.

A preferred embodiment of the thermal storage apparatus and the thermal storage system using the thermal storage medium of the present invention is a thermal storage apparatus or a thermal storage system using a thermal storage medium in a form of the water dispersion in an emulsion form and provided with a line mixer, namely, a thermal storage apparatus or a thermal storage system to which the process for producing of the present invention is applied. By employing such a form, the dispersed condition of the thermal storage medium is retained, and therefore thermal storage apparatuses and thermal storage systems can become one which can be favorably used for the purpose of a saving in air conditioning energy, an increase in efficiency thereof and environmental protection. And, even when the dispersion of the oil substance in a thermal storage tank is broken due to the repetition of the phase change, it can be re-dispersed by using the line mixer provided to the thermal storage apparatus.

The present invention is also a thermal storage system including the thermal storage apparatus obtained by using the thermal storage medium comprising the oil substance having the thermal storing property by phase change, the aqueous medium and the dispersant as essential, in which the thermal storage apparatus is provided with a line mixer. Though the thermal storage medium used in the above thermal storage system is not specifically limited, it is preferably the one produced by the process for producing of the present invention. By employing such an aspect, it is possible to adequately exert the same effect as the thermal storage system described above.

Since the thermal storage medium of the present invention has high fluidity at the thermal storage temperature, stability and durability and therefore the solidifying point is easily adjusted so as to the thermal storage efficiency is improved, or is easy to solidify in storing heat and able to lower the temperature during releasing heat because a solidifying point and a melting point are approaching each other and further attains an improvement in a thermal storage performance because of having a higher latent heat. Therefore, it is superior as the materials constituting thermal storage apparatuses and thermal storage systems used for the purpose of saving and increasing efficiency of air conditioning energy for large constructions such as office buildings and factories and for home use, and environmental protection.

The thermal storage medium of the present invention is constituted as described above, and can be favorably used for the purpose of saving and increasing efficiency of air conditioning energy and environmental protection because the change in the volume average particle diameter of the dispersion falls within a specific range when the repetition of solidification/melting based on the phase change is conducted on the dispersion of the oil substance, and further by adjusting the concentration of the dispersant in the dispersant aqueous solution in conformity with purposes of usage, it becomes easy to use as a thermal storage medium and attains an improvement in durability. Because of its having excellent fluidity during storage of heat, the operation of system becomes easy and it is superior as the materials constituting thermal storage apparatuses and thermal storage systems used for the purpose of saving and increasing efficiency in air conditioning energy for large constructions such as office buildings and factories and for home use, and environmental protection.

### BRIEF DESCRIPTION OF THE DRAWINGS

FIG. 1 is a schematic diagram representing one embodiment using a production apparatus 1 in the process for producing of the present invention.

FIG. 2 is a schematic diagram representing one embodiment using a production apparatus 11 in the process for producing of the present invention.

FIG. 3 is a schematic diagram representing a mixing tank for producing a conventional thermal storage material.

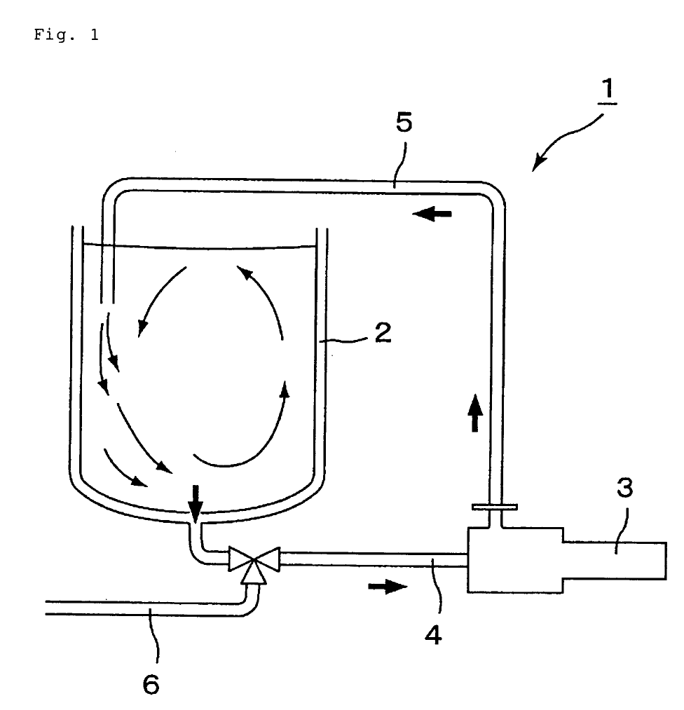

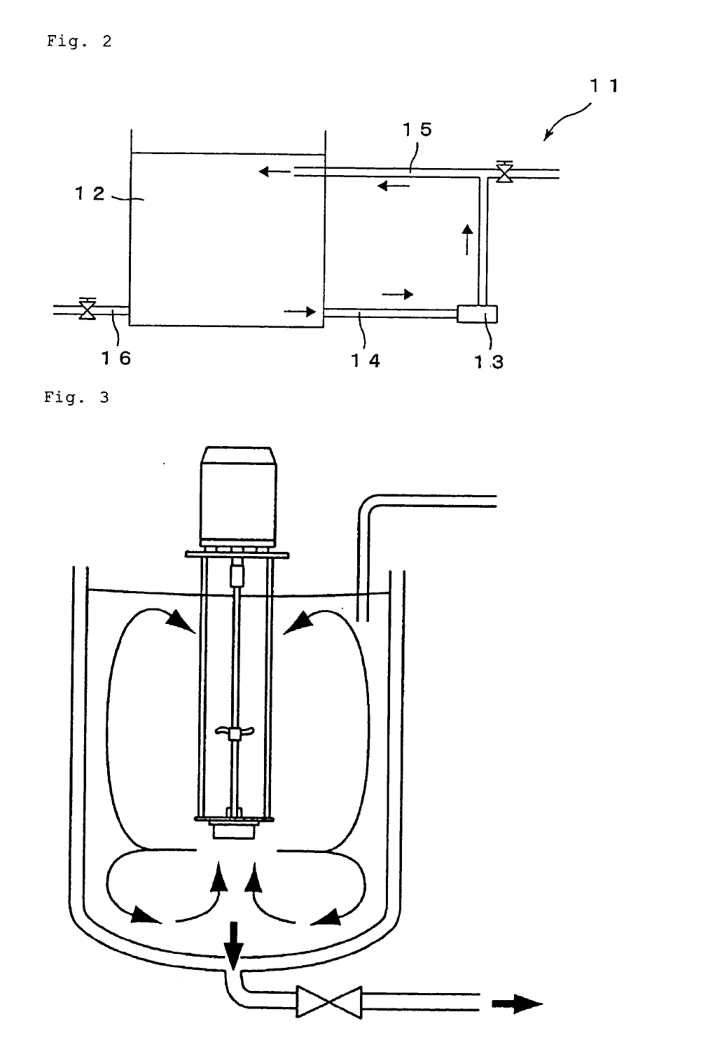

### EXPLANATIONS OF NUMERALS

1 Production apparatus

2 Tank

3 Line mixer

4, 5, 6 Piping

11 Production apparatus

12 Tank

13 Line mixer

14, 15, 16 Piping

### BEST MODES FOR CARRYING OUT THE INVENTION

The following examples illustrate the present invention in further detail without defining the scope of the invention. Unless otherwise indicated, all “parts” are “parts by weight” and all “percentages (%)” are “% by mass”.

### EXAMPLE 1

In a beaker, 1.5 parts of polyoxyethylene (the average molar number of addition of ethylene oxide is 20) stearyl ether (Nonion S-220, produced by NOF Corp.) as a nonionic surfactant was added to 48.0 parts of water, and the mixture was stirred to obtain an aqueous solution dissolved. Then, to 50.0 parts of paraffin (tetradecane 19.4% by mass, pentadecane 73.5% by mass, hexadecane 6.9% by mass, heptadecane 0.2% by mass, number of components: 4, variance: 0.44) distilled from kerosene as an oil substance, 0.5 parts of sucrose fatty acid ester (SUGAR WAX A-10E, produced by Dai-Ichi Kogyo Seiyaku Co., Ltd.) was dissolved and the above aqueous solution was added, and then the mixture was emulsified using a mixer (T. K. HOMO MIXER, manufactured by Tokushu Kika Kogyo Co., Ltd.). A water dispersion in which paraffin was dispersed was obtained. Thereby, a thermal storage medium (a water dispersion) 1 in accordance with the present invention was obtained. A volume-average particle diameter of the thermal storage medium 1 was measured by using a particle size distribution analyzer. As the particle size distribution analyzer, Laser Diffraction Particle Size Analyzer SALD-3000 manufactured by SHIMADZU CORP. was used, and deionized water was used for a measuring medium. The thermal storage medium was added to the deionized water so as to attain the concentration falling within a measuring range, namely, the measuring concentration was adjusted, and the volume average particle diameter was measured. The volume average particle diameter of the thermal storage medium 1 was 2.97 μm.

With respect to the obtained thermal storage-medium 1, a solidifying temperature was determined by differential scanning calorimetry (DSC) under a specified condition. As differential scanning calorimetry (DSC), a differential scanning calorimeter DSC-3100S manufactured by MAC Science Co., Ltd. was used. The measuring conditions were: the temperature was cooled from 25° C. to −20° C. at a speed of 2° C./min, followed by increasing the temperature from −20° C. to 25° C. at a speed of 2° C./min. Consequently, the solidifying temperature (solidifying initiation temperature) was 7.4° C.

When used for cooling applications, a water dispersion which is the thermal storage medium was cooled to 4° C.; because the concentration of the polyoxyethylene (the average molar number of addition of ethylene oxide is 20) stearyl ether used in the Example 1 in the saturated aqueous solution at 4° C. was 27% by mass and the aqueous solution of the surfactant prepared in the Example 1 has a concentration of not higher than the saturated concentration, the fluidity of the thermal storage medium 1 at 4° C. was good. The cloud point was not less than 60° C.

Further, the repetition of solidification/melting in which the oil substance was solidified at 4° C. and melted at 12° C. was conducted. The repetition of solidification/melting was conducted 250 times and the volume average particle diameter was measured to give a result of 3.96 μm. The change of the volume-average particle diameter of the dispersion was as small as +33% and the thermal storage medium was stable in the repetition of the solidification/melting.

### EXAMPLE 2

A beaker was charged with an aqueous solution obtained by dissolving 1.5 parts of polyoxyethylene (20) sorbitan monostearate (RHEODOL TW-S120, produced by KAO Corporation) as a nonionic surfactant into 48.0 parts of water and a solution obtained by dissolving 0.5 part of sucrose fatty acid ester (SUGAR WAX A-10E, produced by Dai-Ichi Kogyo Seiyaku Co., Ltd.) into 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.). A water dispersion in which paraffin was dispersed was obtained. Thereby, a thermal storage medium (a water dispersion) 2 in accordance with the present invention was obtained. The volume average particle diameter of the thermal storage medium 2 was 3 μm.

With respect to the obtained thermal storage medium 2, a solidifying temperature was determined by differential scanning calorimetry (DSC) under a specified condition. As differential scanning calorimetry (DSC), a differential scanning calorimeter DSC-3100S manufactured by MAC Science Co., Ltd. was used. The measuring conditions were: the temperature was cooled from 25° C. to −20° C. at a speed of 2° C./min, followed by increasing the temperature from −20° C. to 25° C. at a speed of 2° C./min. Consequently, the solidifying temperature (solidifying initiation temperature) was 7.6° C.

The fluidity of the thermal storage medium 2 at 4° C. was good because the concentration of the polyoxyethylene sorbitan alkyl ester used in the Example 2 in the saturated aqueous solution at 4° C. was 18% by mass and the aqueous solution of the surfactant prepared in the Example 2 had concentration of not higher than the saturated concentration. The cloud point was not less than 60° C.

The repetition of solidification/melting was conducted 50 times on the thermal storage medium 2 in a similar way, and the change in the volume average particle diameter was within 50%.

### EXAMPLE 3

A beaker was charged with 1.5 parts of polyoxyethylene stearyl ether (Nonion S-220, produced by NOF Corp.) as a nonionic surfactant, an aqueous solution obtained by dissolving 0.5 part of polyvinylpyrrolidone (produced by Nippon Shokubai Co., Ltd., molecular weight: about 120,000) as a polymer dispersant into 47.5 parts of water and a solution obtained by dissolving 0.5 part of sucrose fatty acid ester (SUGAR WAX A-10E, produced by Dai-ichi Kogyo Seiyaku Co., Ltd.) into 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMOMIXER, manufactured by Tokushu Kika Kogyo Co., Ltd.). A water dispersion in which paraffin was dispersed was obtained. Thereby, a thermal storage medium (a water dispersion) 3 in accordance with the present invention was obtained.

With respect to the obtained thermal storage medium 3, a solidifying temperature was determined by differential scanning calorimetry (DSC) under a specified condition. As differential scanning calorimetry (DSC), a differential scanning calorimeter DSC-3100S manufactured by MAC Science Co., Ltd. was used. The measuring conditions were: the temperature was cooled from 25° C. to −20° C. at a speed of 2° C./min, followed by increasing the temperature from −20° C. to 25° C. at a speed of 2° C./min. Consequently, the solidifying temperature (solidifying initiation temperature) was 6.5° C. The fluidity of the thermal storage medium 3 at 5° C. was good.

A volume average particle diameter of the thermal storage medium 3 was measured by using a particle size distribution analyzer. As the particle size distribution analyzer, Laser Diffraction Particle Size Analyzer SALD-3000 manufactured by SHIMADZU CORP. was used. The volume average particle diameter of the thermal storage medium 3 was 2.94 μm.

The repetition of solidification/melting in which the oil substance was solidified at 5° C. and melted at 12° C. was conducted 50 times on the thermal storage medium 3 for evaluation, and the change in the volume average particle diameter was found to be within 50%. The repetition of solidification/melting was further conducted 250 times and the volume average particle diameter was measured to give a result of 2.90 μm. The change of the volume average particle diameter of the dispersion was as small as −1% and the thermal storage medium was stable in the repetition of solidification/melting.

### EXAMPLE 4

A beaker was charged with 1.5 parts of polyoxyethylene stearyl ether (Nonion S-220, produced by NOF Corp.) as a nonionic surfactant, an aqueous solution obtained by dissolving 0.05 part of polyvinyl alcohol (produced by Nippon Synthetic Chemical Industry Co., Ltd., GOHSENOL KH-20, molecular weight: about 100,000) as a polymer dispersant into 47.95 parts of water and a solution obtained by dissolving 0.5 part of sucrose fatty acid ester (SUGAR WAX A-10E, produced by Dai-Ichi Kogyo Seiyaku Co., Ltd.) into 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.). A water dispersion in which paraffin was dispersed was obtained. Thereby, a thermal storage medium (a water dispersion) 4 in accordance with the present invention was obtained.

With respect to the obtained thermal storage medium 4, a solidifying temperature was determined by differential scanning calorimetry (DSC) under a specified condition. As a result, the solidifying temperature (solidifying initiation temperature) was 7.2° C. The fluidity of the thermal storage medium 2 at 5° C. was good.

A volume average particle diameter of the thermal storage medium 4 was measured in a similar manner by using a particle size distribution analyzer. The volume average particle diameter of the thermal storage medium 4 was 3.02 μm.

The repetition of solidification/melting in which the oil substance was solidified at 5° C. and melted at 12° C. was conducted 50 times on the thermal storage medium 4 for evaluation, and the change in the volume average particle diameter was found to be within 50%. The repetition of solidification/melting was further conducted 140 times and the volume average particle diameter was measured to give a result of 2.99 μm. The change of the volume average particle diameter of the dispersion was as small as −1% and the thermal storage medium was stable in the repetition of solidification/melting.

### EXAMPLE 5

A beaker was charged with 1.5 parts of polyoxyethylene stearyl ether (Nonion S-220, produced by NOF Corp.) as a nonionic surfactant, an aqueous solution obtained by dissolving 0.05 part of sodium polyacrylate (produced by Nippon Shokubai Co., Ltd., AQUALIC IH-L, molecular weight: about 1,500,000) as a polymer dispersant into 47.95 parts of water and a solution obtained by dissolving 0.5 part of sucrose fatty acid ester (SUGAR WAX A-10E, produced by Dai-Ichi Kogyo Seiyaku Co., Ltd.) into 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.). A water dispersion in which paraffin was dispersed was obtained. Thereby, a thermal storage medium (a water dispersion) 5 in accordance with the present invention was obtained.

With respect to the obtained thermal storage medium 5, a solidifying temperature was determined by differential scanning calorimetry (DSC) under a specified condition. As a result, the solidifying temperature (solidifying initiation temperature) was 6.5° C. The fluidity of the thermal storage medium 5 at 5° C. was good.

A volume average particle diameter of the thermal storage medium 5 was measured in a similar manner by using a particle size distribution analyzer. The volume average particle diameter of the thermal storage medium 5 was 3.16 μm.

The repetition of solidification/melting in which the oil substance was solidified at 5° C. and melted at 12° C. was conducted 50 times on the thermal storage medium 5 for evaluation, and the change in the volume average particle diameter was found to be within 50%. The repetition of solidification/melting was further conducted 140 times and the volume average particle diameter was measured to give a result of 3.36 μm. The change of the volume average particle diameter of the dispersion was as small as +6% and the thermal storage medium was stable in the repetition of solidification/melting.

### EXAMPLE 6

A beaker was charged with 1.5 parts of polyoxyethylene stearyl ether (Nonion S-220, produced by NOF Corp.) as a nonionic surfactant, an aqueous solution obtained by dissolving 0.5 part of sodium polyacrylate (produced by Nippon Shokubai Co., Ltd., AQUALIC DL522, molecular weight: about 170,000) as a polymer dispersant into 47.5 parts of water and a solution obtained by dissolving 0.5 part of sucrose fatty acid ester (SUGAR WAX A-10E, produced by Dai-Ichi Kogyo Seiyaku Co., Ltd.) into 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.). A water dispersion in which paraffin was dispersed was obtained. Thereby, a thermal storage medium (a water dispersion) 6 in accordance with the present invention was obtained.

With respect to the obtained thermal storage medium 6, a solidifying temperature was determined by differential scanning calorimetry (DSC) under a specified condition. As a result, the solidifying temperature (solidifying initiation temperature) was 6.9° C. The fluidity of the thermal storage medium 6 at 5° C. was good.

A volume average particle diameter of the thermal storage medium 6 was measured in a similar manner by using a particle size distribution analyzer. The volume average particle diameter of the thermal storage medium 6 was 2.64 μm.

The repetition of solidification/melting in which the oil substance was solidified at 5° C. and melted at 12° C. was conducted 50 times on the thermal storage medium 6 for evaluation, and the change in the volume average particle diameter was found to be within 50%. The repetition of solidification/melting was further conducted 20 times and the volume average particle diameter was measured to give a result of 2.70 μm. The change of the volume average particle diameter of the dispersion was as small as +2% and the thermal storage medium was stable in the repetition of solidification/melting.

### EXAMPLE 7

A beaker was charged with 1.5 parts of polyoxyethylene stearyl ether (Nonion S-220, produced by NOF Corp.) as a nonionic surfactant, an aqueous solution obtained by dissolving 0.5 part of polyethyleneimine (produced by Nippon Shokubai Co., Ltd., EPOMIN P-1000, molecular weight: about 70,000) as a polymer dispersant into 47.5 parts of water and a solution obtained by dissolving 0.5 part of sucrose fatty acid ester (SUGAR WAX A-10E, produced by Dai-ichi Kogyo Seiyaku Co., Ltd.) into 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.). A water dispersion in which paraffin was dispersed was obtained. Thereby, a thermal storage medium (a water dispersion) 7 in accordance with the present invention was obtained.

With respect to the obtained thermal storage medium 7, a solidifying temperature was determined by differential scanning calorimetry (DSC) under a specified condition. As a result, the solidifying temperature (solidifying initiation temperature) was 6.9° C. The fluidity of the thermal storage medium 7 at 5° C. was good.

A volume average particle diameter of the thermal storage medium 7 was measured in a similar manner by using a particle size distribution analyzer. The volume average particle diameter of the thermal storage medium 7 was 2.64 μm.

The repetition of solidification/melting in which the oil substance was solidified at 5° C. and melted at 12° C. was conducted 50 times on the thermal storage medium 7 for evaluation, and the change in the volume average particle diameter was found to be within 50%. The repetition of solidification/melting was further conducted 20 times and the volume average particle diameter was measured to give a result of 2.71 μm. The change of the volume average particle diameter of the dispersion was as small as +3% and the thermal storage medium was stable in the repetition of solidification/melting.

### EXAMPLE 8

A beaker was charged with 1.5 parts of polyoxyethylene sorbitan alkyl ester (RHEODOL SUPER TWL-120, produced by Kao Corporation) as a nonionic surfactant, an aqueous solution obtained by dissolving 0.005 part of hydroxypropyl methylcellulose (produced by Shin-Etsu Chemical Co., Ltd., hiMETOLOSE hi90SH100000) as a polymer dispersant into 47.995 parts of water and a solution obtained by dissolving 0.5 part of sucrose fatty acid ester (SUGARWAXA-10E, produced by Dai-ichi Kogyo Seiyaku Co., Ltd.) into 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.). A water dispersion in which paraffin was dispersed was obtained. Thereby, a thermal storage medium (a water dispersion) 8 in accordance with the present invention was obtained. With respect to the obtained thermal storage medium 8, a solidifying temperature was determined by differential scanning calorimetry (DSC) under a specified condition. As a result, the solidifying temperature (solidifying initiation temperature) was 7.9° C. The fluidity of the thermal storage medium 8 at 5° C. was good.

A volume average particle diameter of the thermal storage medium 8 was measured in a similar manner by using a particle size distribution analyzer. The volume average particle diameter of the thermal storage medium 8 was 3.09 μm.

The repetition of solidification/melting in which the oil substance was solidified at 5° C. and melted at 12° C. was conducted 50 times on the thermal storage medium 8 for evaluation, and the change in the volume average particle diameter was found to be within 50%. The repetition of solidification/melting was further conducted 100 times and the volume average particle diameter was measured and the thermal storage medium was stable in the repetition of solidification/melting.

### EXAMPLE 9

A container was charged with an aqueous solution obtained by dissolving 1.5 parts of polyoxyethylene (the average molar number of addition of ethylene oxide is 20) stearyl ether (Nonion S-220, produced by NOF Corp.) as a nonionic surfactant into 48.0 parts of water and a solution obtained by dissolving 0.5 part of sucrose fatty acid ester (SUGARWAXA-10E, produced by Dai-Ichi Kogyo Seiyaku Co., Ltd.) in 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.). A water-dispersion in which paraffin was dispersed was obtained. Thereby, a thermal storage medium (a water-dispersion) 9 in accordance with the present invention was obtained.

A volume average particle diameter of the thermal storage medium 9 was 2.9 μm. The viscosity of the resulting thermal storage medium 9 was measured at 4° C. by using a B8L type viscometer (manufactured by TOKIMEC INC.). The viscosity was 1446 mPa·s and the fluidity was good.

The repetition of solidification/melting was conducted 50 times on the thermal storage medium 9 in a similar way for evaluation, and the change in the volume average particle diameter was found to be within 50%.

### EXAMPLE 10

A container was charged with an aqueous solution obtained by dissolving 1.5 parts of polyoxyethylene (the average molar number of addition of ethylene oxide is 20) sorbitan monostearate (RHEODOL TW-S120, produced by Kao Corporation) as a nonionic surfactant into 48.0 parts of water and a solution obtained by dissolving 0.5 part of sucrose fatty acid ester (SUGAR WAX A-10E, produced by Dai-Ichi Kogyo Seiyaku Co., Ltd.) in 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.). A water-dispersion in which paraffin was dispersed was obtained. Thereby, a thermal storage medium (a water-dispersion) 10 in accordance with the present invention was obtained.

A volume average particle diameter of the thermal storage medium 10 was 2.9 μm. The viscosity of the resulting thermal storage medium 10 was measured at 4° C. by using the B8L type viscometer. The viscosity was 96 mPa·s and the fluidity was good.

The repetition of solidification/melting in which the oil substance was solidified at 4° C. and melted at 12° C. was conducted 50 times on the thermal storage medium 10 for evaluation, and the change in the volume average particle diameter was found to be within 50%. The repetition of solidification/melting was further conducted 70 times and the viscosity was measured at 4° C. to obtain a result of 90 mPa·s, and the fluidity was good.

### EXAMPLE 11

The repetition of solidification/melting in which the oil substance was solidified at 4° C. and melted at 12° C. was conducted in the presence of a copper plate on the thermal storage medium 9 obtained in the Example 9. The repetition of solidification/melting was conducted 50 times and the change in the volume average particle diameter was found to be within 50%. The repetition of solidification/melting was further conducted 10 times and the viscosity was measured at 4° C. to obtain a result of 1190 mPa·s. The formation of rust of the copper plate was small and the water dispersion was hardly discolored, and the fluidity was good.

### EXAMPLE 12

A container was charged with an aqueous solution obtained by dissolving 1.5 parts of polyoxyethylene stearyl ether (Nonion S-220, produced by NOF Corp.) as a nonionic surfactant into 48.0 parts of water and a solution obtained by dissolving 0.5 part of sucrose fatty acid ester (SUGARWAXA-10E, produced by Dai-Ichi Kogyo Seiyaku Co., Ltd., melting point: about 47° C.) as a nucleating agent in 50.0 parts of pentadecane as an oil substance. The mixture was emulsified using a mixer (T. K. HOMO MIXER, manufactured by Tokushu Kika Kogyo Co., Ltd.) to obtain a water-dispersion in which paraffin was dispersed. Thereby, a thermal storage medium (a water-dispersion) 12 in accordance with the present invention was obtained. An average particle diameter of the thermal storage medium 12 was 2.6 μm.

With respect to the obtained thermal storage medium 12, a solidifying temperature and melting temperature were determined by differential scanning calorimetry (DSC) under a specified condition. As differential scanning calorimetry (DSC), a differential scanning calorimeter DSC-3100S manufactured by MAC Science Co., Ltd. was used. The measuring conditions were: the temperature was cooled from 25° C. to −20° C. at a speed of 2° C./min, followed by increasing the temperature from −20° C. to 25° C. at a speed of 2° C./min.

Consequently, the solidifying temperature (solidifying initiation temperature) was 8.2° C. and the melting temperature (melting peak temperature) was 10.2° C.

In the same container, the oil substance was solidified at 5° C. and melted at 12° C. and re-dispersion thereof was carried out. The average particle diameter of the thermal storage medium 12 after re-dispersion was 2.6 μm. The measurement of differential scanning calorimetry (DSC) was carried out under a specified condition and it was found that the solidifying temperature (solidifying initiation temperature) was 8.2° C. and the melting temperature (melting peak temperature) was 10.1° C.

The repetition of solidification/melting was conducted 50 times on the thermal storage medium 12 in a similar way for evaluation, and the change in the volume average particle diameter was found to be within 50%.

### EXAMPLE 13

A container was charged with an aqueous solution obtained by dissolving 1.5 parts of polyoxyethylene stearyl ether (Nonion S-220, produced by NOF Corp.) as a nonionic surfactant into 48.0 parts of water and a solution obtained by dissolving 0.5 part of sorbitan tristearate (RHEODOL SP-S30, produced by Kao Corporation, melting point: 54° C.) as a nucleating agent in 50.0 parts of pentadecane as an oil substance. The mixture was emulsified using a mixer (T. K. HOMO MIXER, manufactured by Tokushu Kika Kogyo Co., Ltd.) to obtain a water-dispersion in which paraffin was dispersed. Thereby, a thermal storage medium (a water-dispersion) 13 in accordance with the present invention was obtained. An average particle diameter of the thermal storage medium 13 was 2.6 μm.

With respect to the obtained thermal storage medium 13, a solidifying temperature and melting temperature were determined by differential scanning calorimetry (DSC) under a specified condition. Consequently, the solidifying temperature (solidifying initiation temperature) was 9.4° C. and the melting temperature (melting peak temperature) was 10.4° C.

In the same container, the oil substance was solidified at 5° C. and melted at 12° C. and re-dispersion thereof was carried out. The average particle diameter of the thermal storage medium 13 after re-dispersion was 2.5 μm. The measurement of differential scanning calorimetry (DSC) was carried out under a specified condition and it was found that the solidifying temperature (solidifying initiation temperature) was 8.5° C. and the melting temperature (melting peak temperature) was 10.1° C.

The repetition of solidification/melting was conducted 50 times on the thermal storage medium 13 in a similar way for evaluation, and the change in the volume average particle diameter was found to be within 50%.

### EXAMPLE 14

A container was charged with an aqueous solution obtained by dissolving 1.5 parts of polyoxyethylene stearyl ether (Nonion S-220, produced by NOF Corp.) as a nonionic surfactant into 48.5 parts of water and a solution obtained by dissolving 2.5 parts of paraffin wax (PARAFFIN WAX PW130, produced by Nippon Seiro Co., Ltd., melting point: 55° C.) as a nucleating agent in 47.5 parts of pentadecane as an oil substance. The mixture was emulsified using a mixer (T. K. HOMO MIXER, manufactured by Tokushu Kika Kogyo Co., Ltd.) to obtain a water-dispersion in which paraffin was dispersed. Thereby, a thermal storage medium (a water-dispersion) 14 in accordance with the present invention was obtained. An average particle diameter of the thermal storage medium 14 was 3.0 μm.

With respect to the obtained thermal storage medium 14, a solidifying temperature and melting temperature were determined by differential scanning calorimetry (DSC) under a specified condition. Consequently, the solidifying temperature (solidifying initiation temperature) was 8.4° C. and the melting temperature (melting peak temperature) was 10.2° C.

In the same container, the oil substance was solidified at 5° C. and melted at 12° C. and re-dispersion thereof was carried out. The average particle diameter of the thermal storage medium 14 after re-dispersion was 2.6 μm. The measurement of differential scanning calorimetry (DSC) was carried out under a specified condition and it was found that the solidifying temperature (solidifying initiation temperature) was 8.1° C. and the melting temperature (melting peak temperature) was 9.6° C.

The repetition of solidification/melting was conducted 50 times on the thermal storage medium 14 in a similar way for evaluation, and the change in the volume average particle diameter was found to be within 50%.

### EXAMPLE 15

A container was charged with an aqueous solution obtained by dissolving 1.5 parts of polyoxyethylene (20) sorbitan monostearate (RHEODOL TW-S120, produced by Kao Corporation) as a nonionic surfactant into 48.0 parts of water and a solution obtained by dissolving 0.5 part of sucrose fatty acid ester (SUGAR WAXA-10E, produced by Dai-Ichi Kogyo Seiyaku Co., Ltd., melting point: about 47° C.) as a nucleating agent in 50.0 parts of paraffin (tetradecanel 9.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.) to obtain a water-dispersion in which paraffin was dispersed. Thereby, a thermal storage medium (a water-dispersion) 15 in accordance with the present invention was obtained. An average particle diameter of the thermal storage medium 15 was 3.0 μm.

With respect to the obtained thermal storage medium 15, a solidifying temperature and melting temperature were determined by differential scanning calorimetry (DSC) under a specified condition. As differential scanning calorimetry (DSC), a differential scanning calorimeter DSC-3100S manufactured by MAC Science Co., Ltd. was used. The measuring conditions were: the temperature was cooled from 25° C. to −20° C. at a speed of 2° C./min, followed by increasing the temperature from −20° C. to 25° C. at a speed of 2° C./min. Consequently, the solidifying temperature (solidifying initiation temperature) was 6.8° C. and the melting temperature (melting peak temperature) was 8.2° C.

In the same container, the oil substance was solidified at 5° C. and melted at 12° C. and re-dispersion thereof was carried out. The average particle diameter of the thermal storage medium 15 after re-dispersion was 2.9 μm. The measurement of differential scanning calorimetry (DSC) was carried out under a specified condition and it was found that the solidifying temperature (solidifying initiation temperature) was 7.0° C. and the melting temperature (melting peak temperature) was 8.4° C.

The repetition of solidification/melting was conducted 50 times on the thermal storage medium 15 in a similar way for evaluation, and the change in the volume average particle diameter was found to be within 50%.

### EXAMPLE 16

A mixing tank equipped with a circulating pump, a line mixer (a mixer without having a driving portion for agitation: OHR Line Mixer MX-8 designed by OHR CORP.) and pipings was charged with an aqueous solution obtained by adding 1.5 parts of polyoxyethylene (20) stearyl ether (Nonion S-220, produced by NOF Corp.) as a nonionic surfactant to 48.0 parts of water and dissolving, and a solution obtained by dissolving 0.5 part of sucrose fatty acid ester (SUGAR WAX A-10E, produced by DAI-ICHI KOGYO SEIYAKU CO., LTD.) as a nucleating agent in 50.0 parts of paraffin (tetradecane 19.4% by mass, pentadecane 73.5% by mass, hexadecane 6.9% by mass, heptadecane 0.2% by mass) distilled from kerosene as an oil substance. The circulating pump was started to begin the dispersion of paraffin. The circulating pump was stopped after a predetermined time to obtain a water dispersion in which paraffin was dispersed. Thereby, a thermal storage medium (a water dispersion) 16 in accordance with the present invention was obtained. An average particle diameter of the thermal storage medium 16 was 2.8 μm.

With respect to the obtained thermal storage medium 16, a solidification temperature was determined by differential scanning calorimetry (DSC) under a specified condition. The solidification temperature (solidifying initiation temperature) was 7.7° C. and a melting temperature (melting peak temperature) was 8.5° C.

Thereafter, the thermal storage medium 16 was drawn out from the mixing tank and charged to a thermal storage water tank equipped with a circulating pump, a line mixer (a mixer without having a driving portion for agitation: OHR Line Mixer MX-8 designed by OHR CORP.) and pipings. The repetition of solidification/melting in which the oil substance was solidified at 5° C. and melted at 12° C. was conducted 5 times and then, re-dispersion was carried out. The average particle diameter of the thermal storage medium 16 after re-dispersion was 2.8 μm. The measurement by differential scanning calorimetry (DSC) under a specified condition was carried out and it was found that the solidification temperature (solidifying initiation temperature) was 7.9° C. and the melting temperature (melting peak temperature) was 8.4° C.

The repetition of solidification/melting was conducted 50 times on the thermal storage medium 16 for evaluation in a similar way, and the change in the volume average particle diameter was found to be within 50%.

### EXAMPLE 17

A container was charged with 1.5 parts of polyoxyethylene (20) stearyl ether (Nonion S-220, produced by NOF Corp.) as a nonionic surfactant, an aqueous solution obtained by dissolving 0.5 part of polyvinyl pyrrolidone (produced by Nippon Shokubai Co., Ltd., molecular weight: about 120,000) as a polymer dispersant into 47.5 parts of water and a solution obtained by dissolving 0.5 part of sucrose fatty acid ester (SUGAR WAX A-10E, produced by Dai-ichi Kogyo Seiyaku Co., Ltd., melting point: about 47° C.) into 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.) to obtain a water dispersion in which paraffin was dispersed. Thereby, a thermal storage medium (a water dispersion) 17 in accordance with the present invention was obtained. An average particle diameter of the thermal storage medium 17 was 2.8 μm.

With respect to the obtained thermal storage medium 17, a solidifying temperature and melting temperature were determined by differential scanning calorimetry (DSC) under a specified condition. Consequently, the solidifying temperature (solidifying initiation temperature) was 6.8° C. and the melting temperature (melting peak temperature) was 8.2° C.

The thermal storage medium 17 was drawn from the above container, and in a different container, the oil substance was solidified at 5° C. and melted at 12° C. and re-dispersion thereof was carried out. The average particle diameter of the thermal storage medium 17 after re-dispersion was 2.7 μm. The measurement of differential scanning calorimetry (DSC) was carried out under a specified condition and it was found that the solidifying temperature (solidifying initiation temperature) was 7.8° C. and the melting temperature (melting peak temperature) was 8.4° C.

The repetition of solidification/melting was conducted 50 times on the thermal storage medium 17 in a similar way for evaluation, and the change in the volume average particle diameter was found to be within 50%.

### EXAMPLE 18

A container was charged with 1.5 parts of polyoxyethylene (20) stearyl ether (Nonion S-220, produced by NOF Corp.) as a nonionic surfactant, an aqueous solution obtained by dissolving 0.5 part of sodium polyacrylate (produced by Nippon Shokubai Co., Ltd., AQUALIC DL365, molecular weight: about 5,000) as a polymer dispersant into 47.5 parts of water and a solution obtained by dissolving 0.5 part of sucrose fatty acid ester (SUGAR WAXA-10E, produced by Dai-Ichi Kogyo Seiyaku Co., Ltd., melting point: about 47° C.) into 50.0 parts of paraffin (tetradecane 19.4% by mass, pentadecane 73.5% by mass, hexadecane 6.9% by mass, heptadecane 0.2% by mass) distilled from kerosene as an oil substance. The mixture was emulsified using a mixer (T. K. HOMO MIXER, manufactured by Tokushu Kika Kogyo Co., Ltd.) to obtain a water dispersion in which paraffin was dispersed. Thereby, a thermal storage medium (a water dispersion) 18 in accordance with the present invention was obtained. An average particle diameter of the thermal storage medium 18 was 2.7 μm.

With respect to the obtained thermal storage medium 18, a solidifying temperature and melting temperature were determined by differential scanning calorimetry (DSC) under a specified condition. Consequently, the solidifying temperature (solidifying initiation temperature) was 7.6° C. and the melting temperature (melting peak temperature) was 8.4° C.

The thermal storage medium 18 was drawn out from the above container, and in a different container, the oil substance was solidified at 5° C. and melted at 12° C. and re-dispersion thereof was carried out. The average particle diameter of the thermal storage medium 18 after re-dispersion was 2.7 μm. The measurement of differential scanning calorimetry (DSC) was carried out under a specified condition and it was found that the solidifying temperature (solidifying initiation temperature) was 7.7° C. and the melting temperature (melting peak temperature) was 8.4° C.

The repetition of solidification/melting was conducted 50 times on the thermal storage medium 18 in a similar way for evaluation, and the change in the volume average particle diameter was found to be within 50%.

### EXAMPLE 19

An iron plate was immersed in the thermal storage medium obtained in the Example 9, and the repetition of solidification/melting was conducted 50 times in a similar way for evaluation, to give the change in the volume average particle diameter of within 50%. The repetition of the freezing/melting was further conducted 500 times for evaluation, and separation of paraffin was not observed. The content of iron contained in the thermal storage medium after this evaluation was measured by ICP (Inductively Coupled Plasma; model ULTIMA, manufactured by HORIBA, Ltd.) analysis and a result was 176 ppm.

### EXAMPLE 20

A mixing tank equipped with a circulating pump, a line mixer (a mixer without having a driving portion for agitation: OHR Line Mixer MX-8 designed by OHR CORP.) and pipings was charged with an aqueous solution obtained by adding 1.5 parts of polyoxyethylene alkyl ether (Nonion S-220, produced by NOF Corp.) as a nonionic surfactant to 48.0 parts of water and dissolving, and a solution obtained by dissolving 0.5 part of sucrose fatty acid ester (SUGAR WAX A-10E, produced by DAI-ICHI KOGYO SEIYAKU CO., LTD.) in 50.0 parts of paraffin (tetradecane 19.4% by mass, pentadecane 73.5% by mass, hexadecane 6.9% by mass, heptadecane 0.2% by mass) distilled from kerosene as an oil substance.

The circulating pump was started to begin the dispersion of paraffin as a phase-changing substance. The circulating pump was stopped after a predetermined time to obtain a water dispersion in which paraffin was dispersed. Thereby, a thermal storage medium (a water dispersion) 20 in accordance with the present invention was obtained. An average particle diameter of the thermal storage medium 20 was 3 μm.

With respect to the obtained thermal storage medium 20, a solidification temperature was determined by differential scanning calorimetry (DSC) under a specified condition. The solidification temperature (solidifying initiation temperature) was 7.3° C.

The repetition of solidification/melting was conducted 50 times on the thermal storage medium 20 for evaluation in a similar way, and the change in the volume average particle diameter was found to be within 50%.

### COMPARATIVE EXAMPLE 1

A beaker was charged with an aqueous solution obtained by adding 1.5 parts of polyoxyalkylene (the average molar number of addition of ethylene oxide is 8 to 13 and the average molar number of addition of propylene oxide is 3 to 8) alkyl (alkyl chain 12 to 14) ether (EMULGEN MS-110, produced by KAO Corporation) as nonionic surfactants to 48.0 parts of water and dissolving, and a solution obtained by dissolving 0.5 part of sucrose fatty acid ester (SUGAR WAX A-10E, produced by DAI-ICHI KOGYO SEIYAKU CO., LTD.) in 50.0 parts of paraffin (tetradecane 19.4% by mass, pentadecane 73.5% by mass, hexadecane 6.9% by mass, heptadecane 0.2% by mass) distilled from kerosene as an oil substance. The mixture in the beaker was emulsified using a mixer (T. K. HOMO MIXER, manufactured by Tokushu Kika Kogyo Co., Ltd.).

A water dispersion in which paraffin was dispersed was obtained. Thereby, a comparative thermal storage medium (a water-dispersion) 1 in accordance with the present invention was obtained. The volume average particle diameter of the comparative thermal storage medium 1 was 2.6 μm.

With respect to the comparative thermal storage medium 1 obtained, a solidification temperature was determined by differential scanning calorimetry (DSC) under a specified condition. In differential scanning calorimetry (DSC), a differential scanning calorimeter DSC-3100S manufactured by MAC Science Co., Ltd. was used. The measuring conditions were: the temperature was cooled from 25° C. to −20° C. at a speed of 2° C./min, followed by increasing the temperature from −20° C. to 25° C. at a speed of 2° C./min. Consequently, the solidification temperature (solidification initiation temperature) was 6.7° C. The oil substance was solidified at 4° C. and melted at 12° C. one time, respectively, paraffin was separated like a layer so that it could not be used as the thermal storage medium.

The surfactant used in the Comparative Example 1 dissolved freely in water.

### COMPARATIVE EXAMPLE 2

In a beaker, 5.6 parts of polyoxyethylene (the average molar number of addition of ethylene oxide is 13) stearyl ether (EMULGEN 320P, produced by KAO Corporation) as a nonionic surfactant was added to 43.9 parts of water, and the mixture was stirred to obtain an aqueous solution. Then, 0.5 part of sucrose fatty acid ester (SUGAR WAX A-10E, produced by DAI-ICHI KOGYO SEIYAKU CO., LTD.) was dissolved in 50.0 parts of paraffin (tetradecane 19.4% by mass, pentadecane 73.5% by mass, hexadecane 6.9% by mass, heptadecane 0.2% by mass) distilled from kerosene as an oil substance, and this was added to the above aqueous solution, and then the mixture was emulsified by using a mixer (T. K. HOMOMIXER, manufactured by Tokushu Kika Kogyo Co., Ltd.). A water dispersion in which paraffin was dispersed was obtained. Thereby, a comparative thermal storage medium (a water dispersion) 2 in accordance with the present invention was obtained. An average particle diameter of the comparative thermal storage medium 2 was 2.5 μm.

A solidification temperature of the resulting thermal storage medium 2 was determined by differential scanning calorimetry (DSC) under a specified condition. Consequently, the solidification temperature (solidification initiation temperature) was 6.8° C.

The concentration of the polyoxyethylene (13) stearyl ether used in Comparative Example 2 in the saturated aqueous solution at 4° C. was 0.08% by mass, and the aqueous solution of the surfactant prepared in Comparative Example 2 had a concentration of not lower than the saturated concentration, the fluidity of the comparative thermal storage medium 2 at 4° C. was poor and therefore the comparative thermal storage medium 2 was not suitable for the thermal storage medium.

### COMPARATIVE EXAMPLE 3

A beaker was charged with an aqueous solution obtained by adding 1.5 parts of polyvinyl pyrrolidone (produced by Nippon Shokubai Co., Ltd., molecular weight about 120,000) as a polymer dispersant to 48.0 parts of water and dissolving, and a solution obtained by dissolving 0.5 part of sucrose fatty acid ester (SUGAR WAX A-10E, produced by DAI-ICHI KOGYO SEIYAKU CO., LTD.) in 50.0 parts of paraffin (tetradecane 19.4% by mass, pentadecane 73.5% by mass, hexadecane 6.9% by mass, heptadecane 0.2% by mass) distilled from kerosene as an oil substance. The emulsification was effected by using a mixer (T. K. HOMO MIXER, manufactured by Tokushu Kika Kogyo Co., Ltd.), however, a water dispersion in which paraffin is dispersed could not be obtained.

### COMPARATIVE EXAMPLE 4

The thermal storage medium (a water dispersion) 20 obtained in the Example 20 was charged to a water tank equipped with a circulating pump and pipings. The phase change of paraffin dispersed in the thermal storage medium was conducted by radiating heat after the thermal storage medium in the water tank was cooled. It was found that the paraffin was partially separated in a similar manner in the upper portion of the thermal storage medium in the water tank after the phase change operation. Though this thermal storage medium in the water tank was re-dispersed by using only the circulating pump, the separated paraffin existed at the upper portion of the thermal storage medium in the water tank.

1. A thermal storage medium obtained by dispersing, in an oil-in-water manner, a mixture comprising an oil substance having a thermal storing property by phase change, an aqueous medium and a dispersant,
wherein an amount of change in a volume average particle diameter of a dispersion of said oil substance after carrying out a 50 times of repetition of solidification/melting by phase change is within ±50% relative to a volume average particle diameter before carrying out the repetition of solidification/melting.

2. The thermal storage medium according to claim 1,
wherein said thermal storage medium comprises a nucleating agent.

3. The thermal storage medium according to claim 1,
wherein said dispersant comprises a nonionic surfactant.

4. The thermal storage medium according to claim 1,
wherein said dispersant comprises a surfactant,
said surfactant comprising one having an index of hydrophile-lipophile balance of less than 12 and one having an index of hydrophile-lipophile balance of not less than 12.

5. The thermal storage medium according to claim 4,
wherein said surfactant has an index of hydrophile-lipophile balance of whole surfactant of not less than 5 but not more than 15,
the index being determined from a mass fraction of each surfactant constituting said surfactant.

6. The thermal storage medium according to claim 1,
wherein, in said thermal storage medium, a concentration of the dispersant in a dispersant aqueous solution comprising said aqueous medium and said dispersant at a thermal storage temperature is 0.01 to 4 times as compared to a saturated concentration of the dispersant.

7. The thermal storage medium according to claim 1,
wherein said dispersant comprises at least one species selected from the group consisting of polyoxyethylene alkyl ether and polyoxyethylene sorbitan alkyl ester,
said polyoxyethylene alkyl ether having an average molar number of addition of ethylene oxide of not less than 20 and a total number of carbon atoms of not less than 15, and
said polyoxyethylene sorbitan alkyl ester having an average molar number of addition of ethylene oxide of not less than 20 and a total number of carbon atoms of not less than 15.

8. The thermal storage medium according to claim 1,
wherein said oil substance is constituted by two or more components.

9. The thermal storage medium according to claim 1, wherein a viscosity of said dispersion is 5 to 2,000 mPa·s at 4° C., with a content of said oil substance in said dispersion being 50% by mass.

10. The thermal storage medium according to claim 1,
wherein a viscosity of said dispersion is 5 to 2,000 mPa·s at 4° C., with a content of said oil substance in said dispersion being 50% by mass after carrying out phase change of solidification/melting on said oil substance in said dispersion.

11. The thermal storage medium according to claim 1,
wherein said dispersion comprises a surfactant and a polymer dispersant.

12. The thermal storage medium according to claim 1,
wherein said thermal storage medium is used under contact with or in the presence of metal.

13. A process for producing the thermal storage medium according to claim 1,
which comprises subjecting the thermal storage medium to phase change and then re-dispersing the same,
said thermal storage medium being obtained by dispersing, in an oil-in-water manner, a mixture comprising said oil substance, said aqueous medium and said dispersant.

14. A process for producing the thermal storage medium according to claim 1,
which comprises a step of dispersing said oil substance by using a line mixer.

15. A process for producing the thermal storage medium according to claim 1,
which comprises subjecting the thermal storage medium to phase change and then re-dispersing the same by using a static mixer,
said thermal storage medium being obtained by dispersing, in an oil-in-water manner, a mixture comprising said oil substance, said aqueous medium and said dispersant.

16. A thermal storage apparatus or a thermal storage system,
which is obtained by using the thermal storage medium according to claim 1 or a thermal storage medium produced by the process for producing the thermal storage medium according to any one of claims 13 to 15.
